(19) United States
(12) Patent Application Publication
(10) Pub. No.: US 2025/0110546 A1
(43) Pub. Date: Apr. 3, 2025

(54) USER INTERFACES AND TECHNIQUES FOR CREATING A PERSONALIZED USER EXPERIENCE

(71) Applicant: Apple Inc., Cupertino, CA (US)

(72) Inventors: Arian BEHZADI, San Francisco, CA (US); Christopher P. FOSS, San Francisco, CA (US); Andrew S. KIM, Walnut Creek, CA (US); David A. KRIMSLEY, Sunnyvale, CA (US); Christopher D. MATTHEWS, San Francisco, CA (US); Corey K. WANG, Palo Alto, CA (US)

(21) Appl. No.: 18/896,690

(22) Filed: Sep. 25, 2024

Related U.S. Application Data
(60) Provisional application No. 63/541,813, filed on Sep. 30, 2023.
(60) Provisional application No. 63/541,819, filed on Sep. 30, 2023.
(60) Provisional application No. 63/541,804, filed on Sep. 30, 2023.

(51) Int. Cl. G06F 3/01; G06F 3/0484

(52) U.S. Cl. CPC G06F 3/011; G06F 3/0484

(57) ABSTRACT

The present disclosure generally relates to user interfaces and techniques for creating a personalized user experience in accordance with some examples, such as modifying the operation of a device, displaying an animation representing a change in an operation of a device, and/or displaying a user interface based on a location of a user.

### CROSS-REFERENCE TO RELATED APPLICATIONS

This application claims priority to U.S. Provisional Patent Application Ser. No. 63/541,813 entitled “USER INTERFACES AND TECHNIQUES FOR CREATING A PERSONALIZED USER EXPERIENCE,” filed Sep. 30, 2023, to U.S. Provisional Patent Application Ser. No. 63/541,804 entitled “TECHNIQUES FOR CHANGING DISPLAY OF CONTROLS,” filed Sep. 30, 2023, and to U.S. Provisional Patent Application Ser. No. 63/541,819 entitled “TECHNIQUES FOR ADJUSTING AN OUTPUT OF A DEVICE,” filed Sep. 30, 2023, which are incorporated by reference herein in their entireties for all purposes.

### FIELD

The present disclosure relates generally to computer user interfaces and, more specifically, to techniques for creating an individualized user experience.

### BACKGROUND

Computer systems often display different types of user interfaces. Computer systems can personalize some of these user interfaces for individual users.

### SUMMARY

Some techniques for creating an individualized user experience using computer systems, however, are generally cumbersome and inefficient. For example, some existing techniques use a complex and time-consuming user interfaces, which may include multiple key presses or keystrokes. Existing techniques require more time than necessary, wasting user time and device energy, such as when these user interfaces are not personalized and/or optimized for individual users. This latter consideration is particularly important in battery-operated devices.

Accordingly, the present technique provides computer systems with faster, more efficient methods and interfaces for creating a personalize user experience. Such methods and interfaces optionally complement or replace other methods for creating a personalized user experience. Such methods and interfaces reduce the cognitive burden on a user and produce a more efficient human-machine interface. For battery-operated computing devices, such methods and interfaces conserve power and increase the time between battery charges.

In some embodiments, a method that is performed at a computer system that is in communication with a display component and a first device is described. In some embodiments, the method comprises: while the first device is providing first output, detecting a presence of a user; and in response to detecting the presence of the user: in accordance with a determination that a value of a setting corresponding to the user is a first value and a value of a characteristic of an environment is a second value, causing the first device to provide second output that is different from the first output; in accordance with a determination that the value of the setting corresponding to the user is a third value, different from the first value, and the value of the characteristic of the environment is the second value, causing the first device to provide third output that is different from the second output and the first output; in accordance with a determination that the value of the setting corresponding to the user is the first value and the value of the characteristic of the environment is a fourth value, different from the second value, causing the first device to provide fourth output that is different from the third output, the second output, and the first output; and in accordance with a determination that the value of the setting corresponding to the user is the third value and the value of the characteristic of the environment is the fourth value, causing the first device to provide fifth output that is different from the fourth output, the third output, the second output, and the first output.

In some embodiments, a non-transitory computer-readable storage medium storing one or more programs configured to be executed by one or more processors of a computer system that is in communication with a display component and a first device is described. In some embodiments, the one or more programs includes instructions for: while the first device is providing first output, detecting a presence of a user; and in response to detecting the presence of the user: in accordance with a determination that a value of a setting corresponding to the user is a first value and a value of a characteristic of an environment is a second value, causing the first device to provide second output that is different from the first output; in accordance with a determination that the value of the setting corresponding to the user is a third value, different from the first value, and the value of the characteristic of the environment is the second value, causing the first device to provide third output that is different from the second output and the first output; in accordance with a determination that the value of the setting corresponding to the user is the first value and the value of the characteristic of the environment is a fourth value, different from the second value, causing the first device to provide fourth output that is different from the third output, the second output, and the first output; and in accordance with a determination that the value of the setting corresponding to the user is the third value and the value of the characteristic of the environment is the fourth value, causing the first device to provide fifth output that is different from the fourth output, the third output, the second output, and the first output.

In some embodiments, a transitory computer-readable storage medium storing one or more programs configured to be executed by one or more processors of a computer system that is in communication with a display component and a first device is described. In some embodiments, the one or more programs includes instructions for: while the first device is providing first output, detecting a presence of a user; and in response to detecting the presence of the user: in accordance with a determination that a value of a setting corresponding to the user is a first value and a value of a characteristic of an environment is a second value, causing the first device to provide second output that is different from the first output; in accordance with a determination that the value of the setting corresponding to the user is a third value, different from the first value, and the value of the characteristic of the environment is the second value, causing the first device to provide third output that is different from the second output and the first output; in accordance with a determination that the value of the setting corresponding to the user is the first value and the value of the characteristic of the environment is a fourth value, different from the second value, causing the first device to provide fourth output that is different from the third output, the second output, and the first output; and in accordance with a determination that the value of the setting corresponding to the user is the third value and the value of the characteristic of the environment is the fourth value, causing the first device to provide fifth output that is different from the fourth output, the third output, the second output, and the first output.

In some embodiments, a computer system that is in communication with a display component and a first device is described. In some embodiments, the computer system that is in communication with a display component and a first device comprises one or more processors and memory storing one or more programs configured to be executed by the one or more processors. In some embodiments, the one or more programs includes instructions for: while the first device is providing first output, detecting a presence of a user; and in response to detecting the presence of the user: in accordance with a determination that a value of a setting corresponding to the user is a first value and a value of a characteristic of an environment is a second value, causing the first device to provide second output that is different from the first output; in accordance with a determination that the value of the setting corresponding to the user is a third value, different from the first value, and the value of the characteristic of the environment is the second value, causing the first device to provide third output that is different from the second output and the first output; in accordance with a determination that the value of the setting corresponding to the user is the first value and the value of the characteristic of the environment is a fourth value, different from the second value, causing the first device to provide fourth output that is different from the third output, the second output, and the first output; and in accordance with a determination that the value of the setting corresponding to the user is the third value and the value of the characteristic of the environment is the fourth value, causing the first device to provide fifth output that is different from the fourth output, the third output, the second output, and the first output.

In some embodiments, a computer system that is in communication with a display component and a first device is described. In some embodiments, the computer system that is in communication with a display component and a first device comprises means for performing each of the following steps: while the first device is providing first output, detecting a presence of a user; and in response to detecting the presence of the user: in accordance with a determination that a value of a setting corresponding to the user is a first value and a value of a characteristic of an environment is a second value, causing the first device to provide second output that is different from the first output; in accordance with a determination that the value of the setting corresponding to the user is a third value, different from the first value, and the value of the characteristic of the environment is the second value, causing the first device to provide third output that is different from the second output and the first output; in accordance with a determination that the value of the setting corresponding to the user is the first value and the value of the characteristic of the environment is a fourth value, different from the second value, causing the first device to provide fourth output that is different from the third output, the second output, and the first output; and in accordance with a determination that the value of the setting corresponding to the user is the third value and the value of the characteristic of the environment is the fourth value, causing the first device to provide fifth output that is different from the fourth output, the third output, the second output, and the first output.

In some embodiments, a computer program product is described. In some embodiments, the computer program product comprises one or more programs configured to be executed by one or more processors of a computer system that is in communication with a display component and a first device. In some embodiments, the one or more programs include instructions for: while the first device is providing first output, detecting a presence of a user; and in response to detecting the presence of the user: in accordance with a determination that a value of a setting corresponding to the user is a first value and a value of a characteristic of an environment is a second value, causing the first device to provide second output that is different from the first output; in accordance with a determination that the value of the setting corresponding to the user is a third value, different from the first value, and the value of the characteristic of the environment is the second value, causing the first device to provide third output that is different from the second output and the first output; in accordance with a determination that the value of the setting corresponding to the user is the first value and the value of the characteristic of the environment is a fourth value, different from the second value, causing the first device to provide fourth output that is different from the third output, the second output, and the first output; and in accordance with a determination that the value of the setting corresponding to the user is the third value and the value of the characteristic of the environment is the fourth value, causing the first device to provide fifth output that is different from the fourth output, the third output, the second output, and the first output.

In some embodiments, a method that is performed at a computer system that is in communication with a display component is described. In some embodiments, the method comprises: detecting a presence of a first user; in response to detecting the presence of the first user, displaying, via the display component, a first user interface that includes: a first indication of how output of a first device is changing based on detecting the presence of the first user; and a second indication of how output of a second device is changing based on detecting the presence of the first user, wherein the first indication is different from the second indication; and after displaying the first user interface, displaying, via the display component, a second user interface that does not include the first indication and the second indication and includes: a first control, wherein the first control includes an indication of a value of a first setting corresponding to the first device; and a second control, wherein the second control includes an indication of a value of a second setting corresponding to the second device.

In some embodiments, a non-transitory computer-readable storage medium storing one or more programs configured to be executed by one or more processors of a computer system that is in communication with a display component is described. In some embodiments, the one or more programs includes instructions for: detecting a presence of a first user; in response to detecting the presence of the first user, displaying, via the display component, a first user interface that includes: a first indication of how output of a first device is changing based on detecting the presence of the first user; and a second indication of how output of a second device is changing based on detecting the presence of the first user, wherein the first indication is different from the second indication; and after displaying the first user interface, displaying, via the display component, a second user interface that does not include the first indication and the second indication and includes: a first control, wherein the first control includes an indication of a value of a first setting corresponding to the first device; and a second control, wherein the second control includes an indication of a value of a second setting corresponding to the second device.

In some embodiments, a transitory computer-readable storage medium storing one or more programs configured to be executed by one or more processors of a computer system that is in communication with a display component is described. In some embodiments, the one or more programs includes instructions for: detecting a presence of a first user; in response to detecting the presence of the first user, displaying, via the display component, a first user interface that includes: a first indication of how output of a first device is changing based on detecting the presence of the first user; and a second indication of how output of a second device is changing based on detecting the presence of the first user, wherein the first indication is different from the second indication; and after displaying the first user interface, displaying, via the display component, a second user interface that does not include the first indication and the second indication and includes: a first control, wherein the first control includes an indication of a value of a first setting corresponding to the first device; and a second control, wherein the second control includes an indication of a value of a second setting corresponding to the second device.

In some embodiments, a computer system that is in communication with a display component is described. In some embodiments, the computer system that is in communication with a display component comprises one or more processors and memory storing one or more programs configured to be executed by the one or more processors. In some embodiments, the one or more programs includes instructions for: detecting a presence of a first user; in response to detecting the presence of the first user, displaying, via the display component, a first user interface that includes: a first indication of how output of a first device is changing based on detecting the presence of the first user; and a second indication of how output of a second device is changing based on detecting the presence of the first user, wherein the first indication is different from the second indication; and after displaying the first user interface, displaying, via the display component, a second user interface that does not include the first indication and the second indication and includes: a first control, wherein the first control includes an indication of a value of a first setting corresponding to the first device; and a second control, wherein the second control includes an indication of a value of a second setting corresponding to the second device.

In some embodiments, a computer system that is in communication with a display component is described. In some embodiments, the computer system that is in communication with a display component comprises means for performing each of the following steps: detecting a presence of a first user; in response to detecting the presence of the first user, displaying, via the display component, a first user interface that includes: a first indication of how output of a first device is changing based on detecting the presence of the first user; and a second indication of how output of a second device is changing based on detecting the presence of the first user, wherein the first indication is different from the second indication; and after displaying the first user interface, displaying, via the display component, a second user interface that does not include the first indication and the second indication and includes: a first control, wherein the first control includes an indication of a value of a first setting corresponding to the first device; and a second control, wherein the second control includes an indication of a value of a second setting corresponding to the second device.

In some embodiments, a computer program product is described. In some embodiments, the computer program product comprises one or more programs configured to be executed by one or more processors of a computer system that is in communication with a display component. In some embodiments, the one or more programs include instructions for: detecting a presence of a first user; in response to detecting the presence of the first user, displaying, via the display component, a first user interface that includes: a first indication of how output of a first device is changing based on detecting the presence of the first user; and a second indication of how output of a second device is changing based on detecting the presence of the first user, wherein the first indication is different from the second indication; and after displaying the first user interface, displaying, via the display component, a second user interface that does not include the first indication and the second indication and includes: a first control, wherein the first control includes an indication of a value of a first setting corresponding to the first device; and a second control, wherein the second control includes an indication of a value of a second setting corresponding to the second device.

In some embodiments, a method that is performed at a computer system that is in communication with a first display component and a second display component, different from the first display component is described. In some embodiments, the method comprises: detecting a presence of a user in a physical environment; and in response to detecting the presence of the user: in accordance with a determination that the user is at a first location in the physical environment, displaying, via the first display component, a welcome user interface that includes an indication of how output of one or more devices is being configured based on detecting the presence of the user without displaying, via the second display component, a second welcome user interface; and in accordance with a determination that the user is at a second location, different from the first location, in the physical environment, displaying, via the second display component, the welcome user interface without displaying, via the first display component, a third welcome user interface.

In some embodiments, a non-transitory computer-readable storage medium storing one or more programs configured to be executed by one or more processors of a computer system that is in communication with a first display component and a second display component, different from the first display component is described. In some embodiments, the one or more programs includes instructions for: detecting a presence of a user in a physical environment; and in response to detecting the presence of the user: in accordance with a determination that the user is at a first location in the physical environment, displaying, via the first display component, a welcome user interface that includes an indication of how output of one or more devices is being configured based on detecting the presence of the user without displaying, via the second display component, a second welcome user interface; and in accordance with a determination that the user is at a second location, different from the first location, in the physical environment, displaying, via the second display component, the welcome user interface without displaying, via the first display component, a third welcome user interface.

In some embodiments, a transitory computer-readable storage medium storing one or more programs configured to be executed by one or more processors of a computer system that is in communication with a first display component and a second display component, different from the first display component is described. In some embodiments, the one or more programs includes instructions for: detecting a presence of a user in a physical environment; and in response to detecting the presence of the user: in accordance with a determination that the user is at a first location in the physical environment, displaying, via the first display component, a welcome user interface that includes an indication of how output of one or more devices is being configured based on detecting the presence of the user without displaying, via the second display component, a second welcome user interface; and in accordance with a determination that the user is at a second location, different from the first location, in the physical environment, displaying, via the second display component, the welcome user interface without displaying, via the first display component, a third welcome user interface.

In some embodiments, a computer system that is in communication with a first display component and a second display component, different from the first display component is described. In some embodiments, the computer system that is in communication with a first display component and a second display component, different from the first display component comprises one or more processors and memory storing one or more programs configured to be executed by the one or more processors. In some embodiments, the one or more programs includes instructions for: detecting a presence of a user in a physical environment; and in response to detecting the presence of the user: in accordance with a determination that the user is at a first location in the physical environment, displaying, via the first display component, a welcome user interface that includes an indication of how output of one or more devices is being configured based on detecting the presence of the user without displaying, via the second display component, a second welcome user interface; and in accordance with a determination that the user is at a second location, different from the first location, in the physical environment, displaying, via the second display component, the welcome user interface without displaying, via the first display component, a third welcome user interface.

In some embodiments, a computer system that is in communication with a first display component and a second display component, different from the first display component is described. In some embodiments, the computer system that is in communication with a first display component and a second display component, different from the first display component comprises means for performing each of the following steps: detecting a presence of a user in a physical environment; and in response to detecting the presence of the user: in accordance with a determination that the user is at a first location in the physical environment, displaying, via the first display component, a welcome user interface that includes an indication of how output of one or more devices is being configured based on detecting the presence of the user without displaying, via the second display component, a second welcome user interface; and in accordance with a determination that the user is at a second location, different from the first location, in the physical environment, displaying, via the second display component, the welcome user interface without displaying, via the first display component, a third welcome user interface.

In some embodiments, a computer program product is described. In some embodiments, the computer program product comprises one or more programs configured to be executed by one or more processors of a computer system that is in communication with a first display component and a second display component, different from the first display component. In some embodiments, the one or more programs include instructions for: detecting a presence of a user in a physical environment; and in response to detecting the presence of the user: in accordance with a determination that the user is at a first location in the physical environment, displaying, via the first display component, a welcome user interface that includes an indication of how output of one or more devices is being configured based on detecting the presence of the user without displaying, via the second display component, a second welcome user interface; and in accordance with a determination that the user is at a second location, different from the first location, in the physical environment, displaying, via the second display component, the welcome user interface without displaying, via the first display component, a third welcome user interface.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for creating an individualized user experience, thereby increasing the effectiveness, efficiency, and user satisfaction with such devices. Such methods and interfaces may complement or replace other methods for creating an individualized user experience.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a system with various components in accordance with some embodiments.

FIGS. 2A-2K illustrate exemplary user interfaces for creating a personalized user experience in accordance with some examples.

FIGS. 3A-3B are a flow diagram illustrating a method for modifying the operation of a device in accordance with some examples.

FIG. 4 is a flow diagram illustrating a method for displaying an animation representing a change in an operation of a device in accordance with some examples.

FIGS. 5A-5C illustrate exemplary user interfaces for displaying a user interface based on a location of a user in accordance with some examples.

FIG. 6 is a flow diagram illustrating a method for displaying a user interface based on a location of a user in accordance with some examples.

### DETAILED DESCRIPTION

The following description sets forth exemplary techniques for creating a personalized user experience. This description is not intended to limit the scope of this disclosure but is instead provided as a description of example implementations.

Users need electronic devices that provide effective techniques for creating a personalized user experience. Efficient techniques can reduce a user's mental load when creating a personalized user experience. This reduction in mental load can enhance user productivity and make the device easier to use. In some embodiments, the techniques described herein can reduce battery usage and processing time (e.g., by providing user interfaces that require fewer user inputs to operate).

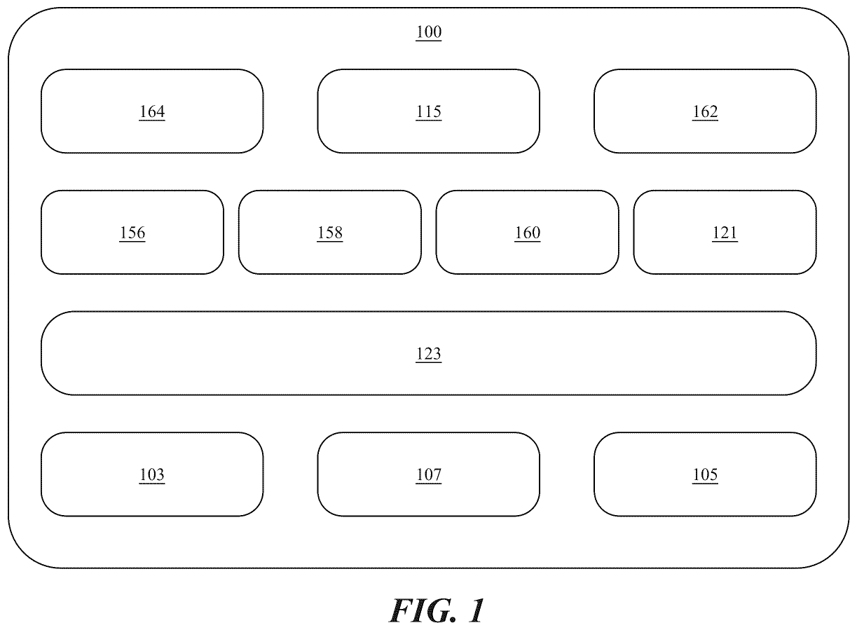

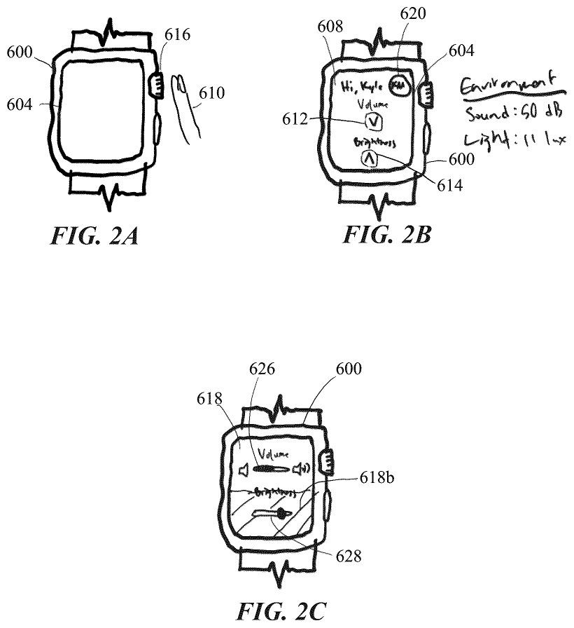

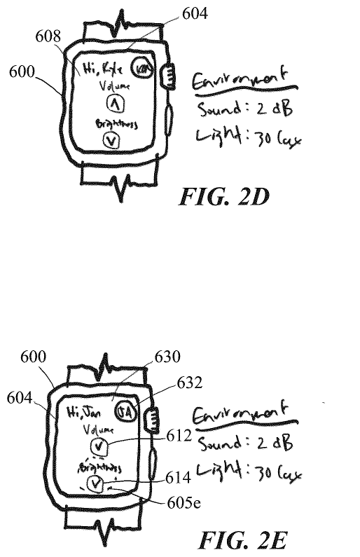

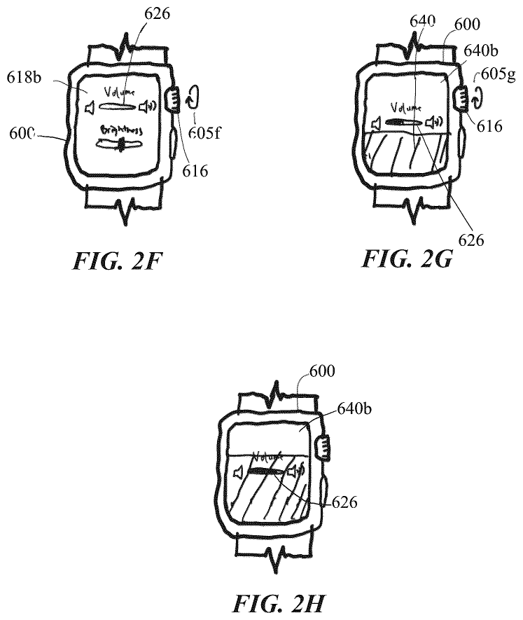

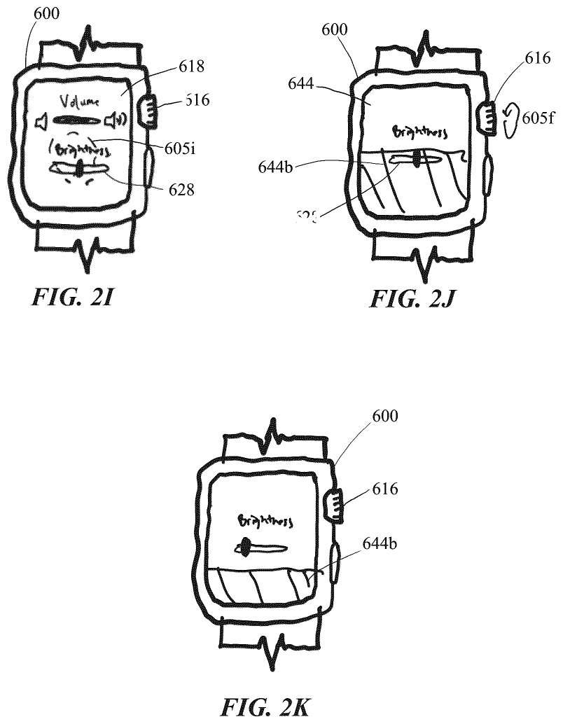

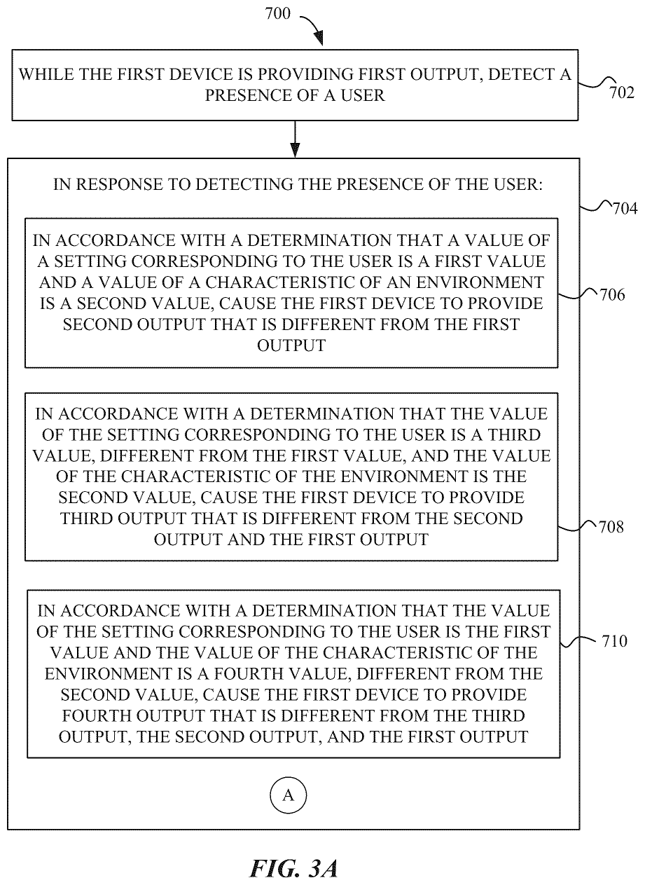

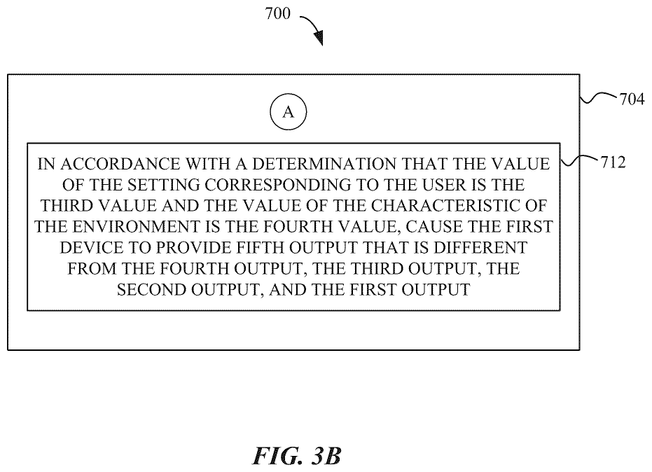

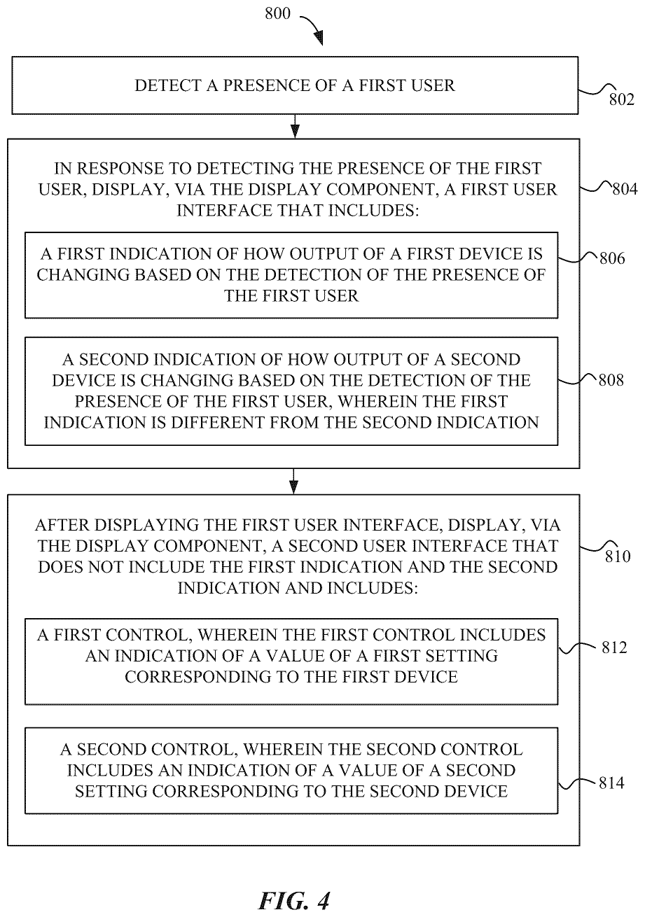

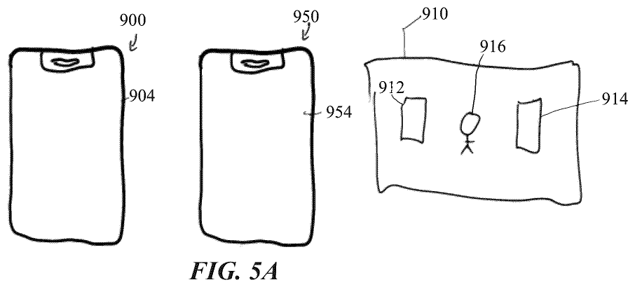

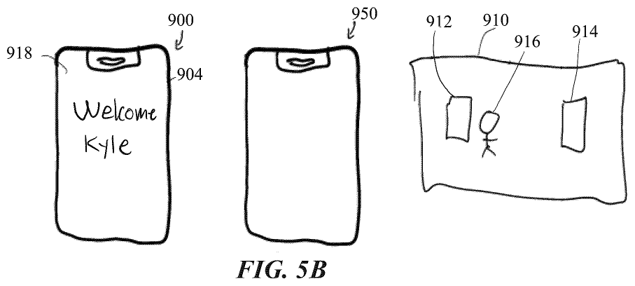

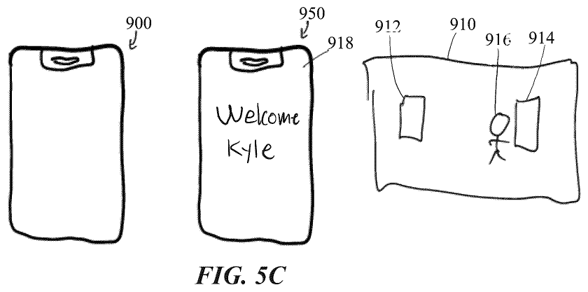

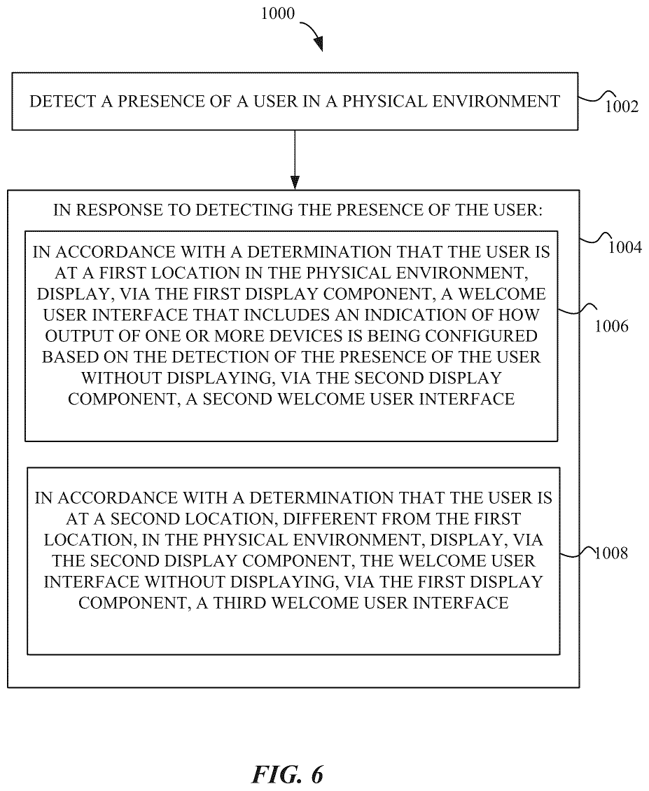

FIG. 1 provides illustrations of exemplary devices for performing techniques for creating a personalized user experience. FIGS. 2A-2K illustrate exemplary user interfaces for creating a personalized user experience in accordance with some examples. FIGS. 3A-3B are a flow diagram illustrating methods of modifying the operation of a device in accordance with some examples. FIG. 4 is a flow diagram illustrating a method for displaying an animation representing a change in an operation of a device in accordance with some examples. The user interfaces in FIGS. 2A-2K are used to illustrate the processes described below, including the processes in FIGS. 3A-3B and 4. FIGS. 5A-5C illustrate exemplary user interfaces for displaying a user interface based on a location of a user in accordance with some examples. FIG. 6 is a flow diagram illustrating methods of displaying a user interface based on a location of a user in accordance with some examples. The user interfaces in FIGS. 5A-5C are used to illustrate the processes described below, including the processes in FIG. 6.

The processes below describe various techniques for making user interfaces and/or human-computer interactions more efficient (e.g., by helping the user to quickly and easily provide inputs and preventing user mistakes when operating a device). These techniques sometimes reduce the number of inputs needed for a user (e.g., a person and/or a user) to perform an operation, provide clear and/or meaningful feedback (e.g., visual, acoustic, and/or haptic feedback) to the user so that the user knows what has happened or what to expect, provide additional information and controls without cluttering the user interface, and/or perform certain operations without requiring further input from the user. Since the user can use a device more quickly and easily, these techniques sometimes improve battery life and/or reduce power usage of the device.

In methods described where one or more steps are contingent on one or more conditions having been satisfied, it should be understood that the described method can be repeated in multiple repetitions so that over the course of the repetitions all of the conditions upon which steps in the method are contingent have been satisfied in different repetitions of the method. For example, if a method requires performing a first step if a condition is satisfied, and a second step if the condition is not satisfied, it should be appreciated that the steps are repeated until the condition has been both satisfied and not satisfied, in no particular order. Thus, a method described with one or more steps that are contingent upon one or more conditions having been satisfied could be rewritten as a method that is repeated until each of the conditions described in the method has been satisfied. This multiple repetition, however, is not required of system or computer readable medium claims where the system or computer readable medium contains instructions for performing conditional operations that require that one or more conditions be satisfied before the operations occur. A person having ordinary skill in the art would also understand that, similar to a method with conditional steps, a system or computer readable storage medium can repeat the steps of a method as many times as are needed to ensure that all of the conditional steps have been performed.

The terminology used in the description of the various embodiments is for the purpose of describing particular embodiments only and is not intended to be limiting.

User interfaces for electronic devices, and associated processes for using these devices, are described below. In some embodiments, the device is a desktop computer with a touch-sensitive surface (e.g., a touch screen display and/or a touchpad). In other embodiments, the device is a portable, movable, and/or mobile electronic device (e.g., a processor, a smart phone, a smart watch, a tablet, a fitness tracking device, a laptop, a head-mounted display (HMD) device, a communal device, a vehicle, a media device, a smart speaker, a smart display, a robot, a television and/or a personal computing device).

In some embodiments, the electronic device is a computer system that is in communication with a display component (e.g., by wireless or wired communication). The display component may be integrated into the computer system or may be separate from the computer system. Additionally, the display component may be configured to provide visual output to a display (e.g., a liquid crystal display, an OLED display, or CRT display). As used herein, “displaying” content includes causing to display the content (e.g., video data rendered or decoded by a display controller) by transmitting, via a wired or wireless connection, data (e.g., image data or video data) to an integrated or external display component to visually produce the content. In some embodiments, visual output is any output that is capable of being perceived by the human eye, including, and not limited to images, videos, graphs, charts, and other graphical representations of data.

In some embodiments, the electronic device is a computer system that is in communication with an audio generation component (e.g., by wireless or wired communication). The audio generation component may be integrated into the computer system or may be separate from the computer system. Additionally, the audio generation component may be configured to provide audio output. Examples of an audio generation component include a speaker, a home theater system, a soundbar, a headphone, an earphone, an earbud, a television speaker, an augmented reality headset speaker, an audio jack, an optical audio output, a Bluetooth audio output, and/or an HDMI audio output). In some embodiments, audio output is any output that is capable of being perceived by the human ear, including, and not limited to sound waves, music, speech, and/or other audible representations of data.

In the discussion that follows, an electronic device that includes particular input and output devices is described. It should be understood, however, that the electronic device optionally includes one or more other input and/or output devices, such as physical user-interface devices (e.g., a physical keyboard, a mouse, and/or a joystick).

FIG. 1 illustrates an example system 100 for implementing techniques described herein. System 100 can perform any of the methods described in FIGS. 3, 4, and/or 6 (e.g., processes 700, 800, and/or 1000) and/or portions of these methods.

In FIG. 1, system 100 includes various components, such as processor(s) 103, RF circuitry(ies) 105, memory(ies) 107, sensors 156 (e.g., image sensor(s), orientation sensor(s), location sensor(s), heart rate monitor(s), temperature sensor(s)), input device(s) 158 (e.g., camera(s) (e.g., a periscope camera, a telephoto camera, a wide-angle camera, and/or an ultra-wide-angle camera), depth sensor(s), microphone(s), touch sensitive surface(s), hardware input mechanism(s), and/or rotatable input mechanism(s)), mobility components (e.g., actuator(s) (e.g., pneumatic actuator(s), hydraulic actuator(s), and/or electric actuator(s)), motor(s), wheel(s), movable base(s), rotatable component(s), translation component(s), and/or rotatable base(s)) and output device(s) 160 (e.g., speaker(s), display component(s), audio generation component(s), haptic output device(s), display screen(s), projector(s), and/or touch-sensitive display(s)). These components optionally communicate over communication bus(es) 123 of the system. Although shown as separate components, in some implementations, various components can be combined and function as a single component, such as a sensor can be an input device.

In some embodiments, system 100 is a mobile and/or movable device (e.g., a tablet, a smart phone, a laptop, head-mounted display (HMD) device, and or a smartwatch). In other embodiments, system 100 is a desktop computer, an embedded computer, and/or a server.

In some embodiments, processor(s) 103 includes one or more general processors, one or more graphics processors, and/or one or more digital signal processors. In some embodiments, memory (ies) 107 is one or more non-transitory computer-readable storage mediums (e.g., flash memory and/or random-access memory) that store computer-readable instructions configured to be executed by processor(s) 103 to perform techniques described herein.

In some embodiments, RF circuitry (ies) 105 includes circuitry for communicating with electronic devices and/or networks (e.g., the Internet, intranets, and/or a wireless network, such as cellular networks and wireless local area networks (LANs)). In some embodiments, RF circuitry (ies) 105 includes circuitry for communicating using near-field communication and/or short-range communication, such as Bluetooth® or Ultra-wideband.

In some embodiments, display(s) 121 includes one or more monitors, projectors, and/or screens. In some embodiments, display(s) 121 includes a first display for displaying images to a first eye of a user and a second display for displaying images to a second eye of the user. In such embodiments, corresponding images can be simultaneously displayed on the first display and the second display. Optionally, the corresponding images include the same virtual objects and/or representations of the same physical objects from different viewpoints, resulting in a parallax effect that provides the user with the illusion of depth of the objects on the displays. In some embodiments, display(s) 121 is a single display. In such embodiments, corresponding images are simultaneously displayed in a first area and a second area of the single display for each eye of the user. Optionally, the corresponding images include the same virtual objects and/or representations of the same physical objects from different viewpoints, resulting in a parallax effect that provides a user with the illusion of depth of the objects on the single display.

In some embodiments, system 100 includes touch-sensitive surface(s) 115 for receiving user inputs, such as tap inputs and swipe inputs. In some embodiments, display(s) 121 and touch-sensitive surface(s) 115 form touch-sensitive display(s).

In some embodiments, sensor(s) 156 includes sensors for detecting various conditions. In some embodiments, sensor(s) 156 includes orientation sensors (e.g., orientation sensor(s) 111) for detecting orientation and/or movement of platform 150. For example, system 100 uses orientation sensors to track changes in the location and/or orientation (sometimes collectively referred to as position) of system 100, such as with respect to physical objects in the physical environment. In some embodiments, sensor(s) 156 includes one or more gyroscopes, one or more inertial measurement units, and/or one or more accelerometers. In some embodiments, sensor(s) 156 includes a global positioning sensor (GPS) for detecting a GPS location of platform 150. In some embodiments, sensor(s) 156 includes a radar system, LIDAR system, sonar system, image sensors (e.g., image sensor(s) 109, visible light image sensor(s), and/or infrared sensor(s)), depth sensor(s), rangefinder(s), and/or motion detector(s). In some embodiments, sensor(s) 156 includes sensors that are in an interior portion of system 100 and/or sensors that are on an exterior of system 100. In some embodiments, system 100 uses sensor(s) 156 (e.g., interior sensors) to detect a presence and/or state (e.g., location and/or orientation) of a passenger in the interior portion of system 100. In some embodiments, system 100 uses sensor(s) 156 (e.g., external sensors) to detect a presence and/or state of an object external to system 100. In some embodiments, system 100 uses sensor(s) 156 to receive user inputs, such as hand gestures and/or other air gesture. In some embodiments, system 100 uses sensor(s) 156 to detect the location and/or orientation of system 100 in the physical environment. In some embodiments, system 100 uses sensor(s) 156 to navigate system 100 along a planned route, around obstacles, and/or to a destination location. In some embodiments, sensor(s) 156 include one or more sensors for identifying and/or authenticating a user of system 100, such as a fingerprint sensor and/or facial recognition sensor.

In some embodiments, image sensor(s) includes one or more visible light image sensor, such as charged coupled device (CCD) sensors, and/or complementary metal-oxide-semiconductor (CMOS) sensors operable to obtain images of physical objects. In some embodiments, image sensor(s) includes one or more infrared (IR) sensor(s), such as a passive IR sensor or an active IR sensor, for detecting infrared light. For example, an active IR sensor can include an IR emitter, such as an IR dot emitter, for emitting infrared light. In some embodiments, image sensor(s) includes one or more camera(s) configured to capture movement of physical objects. In some embodiments, image sensor(s) includes one or more depth sensor(s) configured to detect the distance of physical objects from system 100. In some embodiments, system 100 uses CCD sensors, cameras, and depth sensors in combination to detect the physical environment around system 100. In some embodiments, image sensor(s) includes a first image sensor and a second image sensor different form the first image sensor. In some embodiments, system 100 uses image sensor(s) to receive user inputs, such as hand gestures and/or other air gestures. In some embodiments, system 100 uses image sensor(s) to detect the location and/or orientation of system 100 in the physical environment.

In some embodiments, system 100 uses orientation sensor(s) for detecting orientation and/or movement of system 100. For example, system 100 can use orientation sensor(s) to track changes in the location and/or orientation of system 100, such as with respect to physical objects in the physical environment. In some embodiments, orientation sensor(s) includes one or more gyroscopes, one or more inertial measurement units, and/or one or more accelerometers.

In some embodiments, system 100 uses microphone(s) to detect sound from one or more users and/or the physical environment of the one or more users. In some embodiments, microphone(s) includes an array of microphones (including a plurality of microphones) that optionally operate in tandem, such as to identify ambient noise or to locate the source of sound in space (e.g., inside system 100 and/or outside of system 100) of the physical environment.

In some embodiments, input device(s) 158 includes one or more mechanical and/or electrical devices for detecting input, such as button(s), slider(s), knob(s), switch(es), remote control(s), joystick(s), touch-sensitive surface(s), keypad(s), microphone(s), and/or camera(s). In some embodiments, input device(s) 158 include one or more input devices inside system 100. In some embodiments, input device(s) 158 include one or more input devices (e.g., a touch-sensitive surface and/or keypad) on an exterior of system 100.

In some embodiments, output device(s) 160 include one or more devices, such as display(s), monitor(s), projector(s), speaker(s), light(s), and/or haptic output device(s). In some embodiments, output device(s) 160 includes one or more external output devices, such as external display screen(s), external light(s), and/or external speaker(s). In some embodiments, output device(s) 160 includes one or more internal output devices, such as internal display screen(s), internal light(s), and/or internal speaker(s).

In some embodiments, environmental controls 162 includes mechanical and/or electrical systems for monitoring and/or controlling conditions of an internal portion (e.g., cabin) of system 100. In some embodiments, environmental controls 162 includes fan(s), heater(s), air conditioner(s), and/or thermostat(s) for controlling the temperature and/or airflow within the interior portion of system 100.

In some embodiments, mobility component(s) includes mechanical and/or electrical components that enable a platform to move and/or assist in the movement of the platform. In some embodiments, mobility system 164 includes powertrain(s), drivetrain(s), motor(s) (e.g., an electrical motor), engine(s), power source(s) (e.g., battery (ies)), transmission(s), suspension system(s), speed control system(s), and/or steering system(s). In some embodiments, one or more elements of mobility component(s) are configured to be controlled autonomously or manually (e.g., via system 100 and/or input device(s) 158).

In some embodiments, system 100 performs monetary transactions with or without another computer system. For example, system 100, or another computer system associated with and/or in communication with system 100 (e.g., via a user account described below), is associated with a payment account of a user, such as a credit card account or a checking account. To complete a transaction, system 100 can transmit a key to an entity from which goods and/or services are being purchased that enables the entity to charge the payment account for the transaction. As another example, system 100 stores encrypted payment account information and transmits this information to entities from which goods and/or services are being purchased to complete transactions.

System 100 optionally conducts other transactions with other systems, computers, and/or devices. For example, system 100 conducts transactions to unlock another system, computer, and/or device and/or to be unlocked by another system, computer, and/or device. Unlocking transactions optionally include sending and/or receiving one or more secure cryptographic keys using, for example, RF circuitry (ies) 105.

In some embodiments, system 100 is capable of communicating with other computer systems and/or electronic devices. For example, system 100 can use RF circuitry (ies) 105 to access a network connection that enables transmission of data between systems for the purpose of communication. Example communication sessions include phone calls, e-mails, SMS messages, and/or videoconferencing communication sessions.

In some embodiments, videoconferencing communication sessions include transmission and/or receipt of video and/or audio data between systems participating in the videoconferencing communication sessions, including system 100. In some embodiments, system 100 captures video and/or audio content using sensor(s) 156 to be transmitted to the other system(s) in the videoconferencing communication sessions using RF circuitry (ies) 105. In some embodiments, system 100 receives, using the RF circuitry (ies) 105, video and/or audio from the other system(s) in the videoconferencing communication sessions, and presents the video and/or audio using output device(s) 160, such as display(s) 121 and/or speaker(s). In some embodiments, the transmission of audio and/or video between systems is near real-time, such as being presented to the other system(s) with a delay of less than 0.1, 0.5, 1, or 3 seconds from the time of capturing a respective portion of the audio and/or video.

In some embodiments, the system 100 generates tactile (e.g., haptic) outputs using output device(s) 160. In some embodiments, output device(s) 160 generates the tactile outputs by displacing a moveable mass relative to a neutral position. In some embodiments, tactile outputs are periodic in nature, optionally including frequency (ies) and/or amplitude(s) of movement in two or three dimensions. In some embodiments, system 100 generates a variety of different tactile outputs differing in frequency (ies), amplitude(s), and/or duration/number of cycle(s) of movement included. In some embodiments, tactile output pattern(s) includes a start buffer and/or an end buffer during which the movable mass gradually speeds up and/or slows down at the start and/or at the end of the tactile output, respectively.

In some embodiments, tactile outputs have a corresponding characteristic frequency that affects a “pitch” of a haptic sensation that a user feels. For example, higher frequency (ies) corresponds to faster movement(s) by the moveable mass whereas lower frequency (ies) corresponds to slower movement(s) by the moveable mass. In some embodiments, tactile outputs have a corresponding characteristic amplitude that affects a “strength” of the haptic sensation that the user feels. For example, higher amplitude(s) corresponds to movement over a greater distance by the moveable mass, whereas lower amplitude(s) corresponds to movement over a smaller distance by the moveable mass. In some embodiments, the “pitch” and/or “strength” of a tactile output varies over time.

In some embodiments, tactile outputs are distinct from movement of system 100. For example, system 100 can includes tactile output device(s) that move a moveable mass to generate tactile output and can include other moving part(s), such as motor(s), wheel(s), axel(s), control arm(s), and/or brakes that control movement of system 100. Although movement and/or cessation of movement of system 100 generates vibrations and/or other physical sensations in some situations, these vibrations and/or other physical sensations are distinct from tactile outputs. In some embodiments, system 100 generates tactile output independent from movement of system 100 For example, system 100 can generate a tactile output without accelerating, decelerating, and/or moving system 100 to a new position.

In some embodiments, system 100 detects gesture input(s) made by a user. In some embodiments, gesture input(s) includes touch gesture(s) and/or air gesture(s), as described herein. In some embodiments, touch-sensitive surface(s) 115 identify touch gestures based on contact patterns (e.g., different intensities, timings, and/or motions of objects touching or nearly touching touch-sensitive surface(s) 115). Thus, touch-sensitive surface(s) 115 detect a gesture by detecting a respective contact pattern. For example, detecting a finger-down event followed by detecting a finger-up (e.g., liftoff) event at (e.g., substantially) the same position as the finger-down event (e.g., at the position of a user interface element) can correspond to detecting a tap gesture on the user interface element. As another example, detecting a finger-down event followed by detecting movement of a contact, and subsequently followed by detecting a finger-up (e.g., liftoff) event can correspond to detecting a swipe gesture. Additional and/or alternative touch gestures are possible.

In some embodiments, an air gesture is a gesture that a user performs without touching input device(s) 158. In some embodiments, air gestures are based on detected motion of a portion (e.g., a hand, a finger, and/or a body) of a user through the air. In some embodiments, air gestures include motion of the portion of the user relative to a reference. Example references include a distance of a hand of a user relative to a physical object, such as the ground, an angle of an arm of the user relative to the physical object, and/or movement of a first portion (e.g., hand or finger) of the user relative to a second portion (e.g., shoulder, another hand, or another finger) of the user. In some embodiments, detecting an air gesture includes detecting absolute motion of the portion of the user, such as a tap gesture that includes movement of a hand in a predetermined pose by a predetermined amount and/or speed, or a shake gesture that includes a predetermined speed or amount of rotation of a portion of the user.

In some embodiments, detecting one or more inputs includes detecting speech of a user. In some embodiments, system 100 uses one or more microphones of input device(s) 158 to detect the user speaking one or more words. In some embodiments, system 100 parses and/or communicates information to one or more other systems to determine contents of the speech of the user, including identifying words and/or obtaining a semantic understanding of the words. For example, system processor(s) 103 can be configured to perform natural language processing to detect one or more words and/or determine a likely meaning of the one or more words in the sequence spoken by the user. Additionally or alternatively, in some embodiments, the system 100 determines the meaning of the one or more words in the sequence spoken based upon a context of the user determined by the system 100.

In some embodiments, system 100 outputs spatial audio via output device(s) 160. In some embodiments, spatial audio is output in a particular position. For example, system 100 can play a notification chime having one or more characteristics that cause the notification chime to be generated as if emanating from a first position relative to a current viewpoint of a user (e.g., “spatializing” and/or “spatialization” including audio being modified in amplitude, filtered, and/or delayed to provide a perceived spatial quality to the user).

In some embodiments, system 100 presents visual and/or audio feedback indicating a position of a user relative to a current viewpoint of another user, thereby informing the other user about an updated position of the user. In some embodiments, playing audio corresponding to a user includes changing one or more characteristics of audio obtained from another computer system to mimic an effect of placing an audio source that generates the play back of audio within a position corresponding to the user, such as a position within a three-dimensional environment that the user moves to, spawns at, and/or is assigned to. In some embodiments, a relative magnitude of audio at one or more frequencies and/or groups of frequencies is changed, one or more filters are applied to audio (e.g., directional audio filters), and/or the magnitude of audio provided via one or more channels are changed (e.g., increased or decreased) to create the perceived effect of the physical audio source. In some embodiments, the simulated position of the simulated audio source relative to a floor of the three-dimensional environment matches an elevation of a head of a participant providing audio that is generated by the simulated audio source, or is a predetermined one or more elevations relative to the floor of the three-dimensional environment. In some embodiments, in accordance with a determination that the position of the user will correspond to a second position, different from the first position, and that one or more first criteria are satisfied, system 100 presents feedback including generating audio as if emanating from the second position.

In some embodiments, system 100 communicates with one or more accessory devices. In some embodiments, one or more accessory devices is integrated with system 100. In some embodiments, one or more accessory devices is external to system 100. In some embodiments, system 100 communicates with accessory device(s) using RF circuitry (ies) 105 and/or using a wired connection. In some embodiments, system 100 controls operation of accessory device(s), such as door(s), window(s), lock(s), speaker(s), light(s), and/or camera(s). For example, system 100 can control operation of a motorized door of system 100. As another example, system 100 can control operation of a motorized window included in system 100. In some embodiments, accessory device(s), such as remote control(s) and/or other computer systems (e.g., smartphones, media players, tablets, computers, and/or wearable devices) functioning as input devices control operations of system 100. For example, a wearable device (e.g., a smart watch) functions as a key to initiate operation of an actuation system of system 100. In some embodiments, system 100 acts as an input device to control operations of another system, device, and/or computer, such as the system 100 functioning as a key to initiate operation of an actuation system of a platform associated with another system, device, and/or computer.

In some embodiments, digital assistant(s) help a user perform various functions using system 100. For example, a digital assistant can provide weather updates, set alarms, and perform searches locally and/or using a network connection (e.g., the Internet) via a natural-language interface. In some embodiments, a digital assistant accepts requests at least partially in the form of natural language commands, narratives, requests, statements, and/or inquiries. In some embodiments, a user requests an informational answer and/or performance of a task using the digital assistant. For example, in response to receiving the question “What is the current temperature?,” the digital assistant answers “It is 30 degrees.” As another example, in response to receiving a request to perform a task, such as “Please invite my family to dinner tomorrow,” the digital assistant can acknowledge the request by playing spoken words, such as “Yes, right away,” and then send the requested calendar invitation on behalf of the user to each family member of the user listed in a contacts list for the user. In some embodiments, during performance of a task requested by the user, the digital assistant engages with the user in a sustained conversation involving multiple exchanges of information over a period of time. Other ways of interacting with a digital assistant are possible to request performance of a task and/or request information. For example, the digital assistant can respond to the user in other forms, e.g., displayed alerts, text, videos, animations, music, etc. In some embodiments, the digital assistant includes a client-side portion executed on system 100 and a server-side portion executed on a server in communication with system 100. The client-side portion can communicate with the server through a network connection using RF circuitry (ies) 105. The client-side portion can provide client-side functionalities, input and/or output processing and/or communication with the server, for example. In some embodiments, the server-side portion provides server-side functionalities for any number client-side portions of multiple systems.

In some embodiments, system 100 is associated with one or more user accounts. In some embodiments, system 100 saves and/or encrypts user data, including files, settings, and/or preferences in association with particular user accounts. In some embodiments, user accounts are password-protected and system 100 requires user authentication before accessing user data associated with an account. In some embodiments, user accounts are associated with other system(s), device(s), and/or server(s). In some embodiments, associating one user account with multiple systems enables those systems to access, update, and/or synchronize user data associated with the user account. For example, the systems associated with a user account can have access to purchased media content, a contacts list, communication sessions, payment information, saved passwords, and other user data. Thus, in some embodiments, user accounts provide a secure mechanism for a customized user experience.

Attention is now directed towards embodiments of user interfaces (“UI”) and associated processes that are implemented on an electronic device, such as system 100.

FIGS. 2A-2K illustrate exemplary user interfaces for creating a personalized user experience in accordance with some examples. The user interfaces in these figures are used to illustrate the processes described below, including the processes in FIGS. 3A-3B and 4.

FIGS. 2A-2K are provided to illustrate various examples with respect to how the operation of various devices are adjusted based on user preferences and/or characteristics of the physical environment. In some embodiments, a computer system displays a user interface that indicates one or more preferences of a user. In some embodiments, the computer system animates the display of the indications included in the user interfaces to indicate how the operation of one or more devices are changing. In some embodiments, animating the display of the indications based on how the operation of one or more devices are changing allows a user to easily ascertain the differences between the current state of the one or more devices and the physical environment.

FIG. 2A illustrates computer system 600. As illustrated in FIG. 2A, computer system 600 is a smartwatch and includes display 604 (e.g., a display component) and rotatable input mechanism 616. However, it should be understood that the types of computer systems, user interfaces, user interface objects, and components described herein are merely exemplary and are provided to give context to the embodiments described herein. At FIG. 2A, computer system 600 is coupled to an external structure (e.g., a boat, an airplane, a car, and/or a trailer) that includes at least one or more light devices and a playback device. In some embodiments, computer system 600 includes a knob, a dial, a joystick, a touch-sensitive surface, a button, a slider, a television, a projector, a monitor, a smart display, a laptop, and/or a personal computer. In some embodiments, computer system 600 includes one or more components described above in relation to system 100.

At FIG. 2A, both the one or more light devices and the playback device are powered on and in an operating state (e.g., the one or more light devices are operating at a respective brightness level and the playback device is operating at a respective volume level). Computer system 600 is in communication (e.g., wired and/or wireless communication (Wi-Fi, Bluetooth, and/or Ultra-Wideband)) with the playback device and one or more light devices. At FIG. 2A, computer system 600 is in a sleep mode (e.g., display 604 is inactive). Accordingly, because computer system 600 is in the sleep mode, computer system 600 does not display a respective user interface or any respective user interface objects on display 604. Although computer system 600 is described as being in communication with the playback devices (e.g., speakers) and/or one or more light devices in FIGS. 2A-2G. It should be understood that computer system 600 can be in communication with other devices, such as a window, a door, an air conditioner, a seat, a set of blinds, a lock, a heater, and/or a fan, and one or more similar techniques described herein can be applied to those devices.

At FIG. 2A, the external structure includes both global devices and local devices. Local devices are devices within the external structure whose operation impacts and/or is directed to a portion of the external structure (e.g., not the entirety of the external structure) (e.g., a light device that illuminates a first area of the external structure). The external structure also includes global devices. Global devices are devices within the external structure whose operation impacts and/or is directed to most of the external structure (e.g., a speaker system and/or setting that is directed to the majority of the computer system). In some embodiments, computer system 600 is the external structure.

At FIG. 2A, computer system 600 detects the presence of user 610. In some embodiments, detecting the presence of user 610 includes detecting that user 610 is in a certain position (e.g., user 610 is sitting, user 610 is standing, or user 610 is laying down). In some embodiments, computer system 600 detects the presence of user 610 via one or more cameras that are in communication with computer system 600. In some embodiments, computer system 600 detects the presence of user 610 via a wireless signal that computer system 600 receives from an external computer system (e.g., a computer system external to computer system 600) (e.g., a smartwatch, a fitness tracking device, and/or a smart phone) that is attached to user 610 (e.g., user 610 is wearing and/or holding the external computer system). In some embodiments, detecting the presence of user 610 includes detecting that a hand of user 610 is within a predetermined distance (e.g., 0.25, 0.5, 1, 5, 10, or 12 inches) of display 604. In some embodiments, detecting the presence of user 610 includes detecting that a hand of user 610 is within a predetermined distance of rotatable input mechanism 616. In some embodiments, detecting the presence of user 610 includes detecting that user 610 contacts computer system 600. In some embodiments, when computer system 600 does not detect the presence of user 610, computer system 600 displays a representation of the physical environment on display 604 and displays display 604 with reflective properties (e.g., similar to the reflective properties of a mirror). In some embodiments, when computer system 600 does not detect the presence of user 610, computer system 600 displays display 604 with a transparent appearance. In some embodiments, when computer system 600 does not detect the presence of user 610, computer system 600 displays a representation of the physical environment within a representation of a window on display 604. In some embodiments, when computer system 600 does not detect the presence of user 610, computer system 600 displays a user interface on display 604 that mimics a visual characteristic (e.g., tint, hue, and/or shade) of a portion of the external structure (e.g., the interior of the external structure and/or the external of the external structure).

Each of FIGS. 2B, 2D, and 2E illustrate various scenarios that occur in response to computer system 600 detecting the presence of user 610. FIG. 2B illustrates a first scenario where user 610 is a first user and a physical environment (e.g., an environment within the external structure or outside of the external structure) has a first set of characteristics. Any one of FIG. 2B, 2D, or 2E can follow FIG. 2A. In some embodiments, computer system 600 continues to detect the presence of user 610 in each of FIGS. 2B, 2D, and 2E.

At FIG. 2B, a determination is made that user 610 corresponds to a first user (e.g., a user named Kyle). In response to detecting the presence of user 610 and because a determination is made that user 610 corresponds to Kyle, computer system 600 animates first user welcome user interface 608 as gradually fading into display 604 over a period of time (e.g., 3, 5, 10, 15, 20, 30, 45, or 60 seconds). As illustrated in FIG. 2B, first user welcome user interface 608 includes avatar user interface object 620 (e.g., “KM”) along with a custom salutation to the first user (“Hi, Kyle”). At FIG. 2B, because a determination is made that user 610 corresponds to Kyle, computer system 600 tailors the display of first user welcome user interface 608 for Kyle. Accordingly, avatar user interface object 620 includes a representation of Kyle (e.g., avatar user interface object 620 includes the initials of Kyle and/or includes a graphical representation (e.g., avatar and/or picture) of Kyle. As illustrated in FIG. 2B, first user welcome user interface 608 includes volume user interface object 612 and brightness user interface object 614. Volume user interface object 612 corresponds to the playback device of the external structure. Brightness user interface object 614 corresponds to a set of one or more light devices of the external structure. In some embodiments, computer system 600 ceases to display visual content on display 604 in response to ceasing to detect the presence of user 610.

Each respective user of the external structure has preference levels for various characteristics (e.g., noise, brightness, and/or temperature) of the physical environment. For example, with respect to the noise level in the physical environment, Kyle has a noise preference level of 25 decibels and a brightness preference level of 20 lux. As explained in greater detail below, computer system 600 automatically adjusts the operation of the devices within the external structure based on, in part, the preference levels of a user when the presence of the user is detected. At FIG. 2B, first user welcome user interface 608 does not include an indication of the preference levels of a respective user. Further, at FIG. 2B, the appearance of the background of first user welcome user interface 608 does not correspond to a characteristic of the physical environment and/or a status of a device (e.g., light device, playback device, and/or air conditioning device) within the external structure. In some embodiments, the preference levels for each respective user are preset by the user. In some embodiments, the preference levels for each respective user are inferred by computer system 600. In some embodiments, the preference levels for each respective user are inferred by computer system 600 based on historical habits of the user and/or one or more learned characteristics associated with the user and/or a category of users to which the user belongs.

At FIG. 2B, the output of the playback device is currently causing the physical environment to be at a noise level of 50 decibels (e.g., assuming, for ease of explanation, that there is a direct correlation between volume level of the playback device and noise level in the physical environment). At FIG. 2B, a determination is made that the noise level of the physical environment (50 decibels) is greater than the noise preference level of Kyle (25 decibels). Because a determination is made that the noise level of the physical environment is greater than the noise preference level of Kyle, computer system 600 transmits instructions to the playback device that cause the playback device to decrease the volume level of the playback device. Computer system 600 transmits the instructions to lower the noise level of the physical environment to the noise preference level of Kyle (and/or to lower the noise level of the physical environment to a noise preference level that is within a decibel threshold of the noise preference level of Kyle (e.g., within 1-15 decibels of the nose preference level of Kyle)).

At FIG. 2B, the output of the set of one or more light devices is currently causing the physical environment to be at a brightness level of 11 lux (e.g., assuming, for ease of explanation, that there is a direct correlation between the brightness level of the set of one or more light devices and the brightness level of the physical environment). At FIG. 2B, a determination is made that the brightness level of the physical environment is less than the brightness preference level of Kyle. Because a determination is made that the brightness level of the physical environment is less than the brightness preference level of Kyle, computer system 600 transmits instructions to the set of one or more light devices that that cause the set of one or more light devices to increase the brightness level of the set of one or more light devices such that the brightness level of the physical environment is equal to the brightness preference level of Kyle. That is, computer system 600 adjusts the operation of devices within the external structure to regulate the physical characteristics of the physical environment such that the physical characteristics correspond to Kyle's preferences. In some embodiments, computer system 600 transmits instructions to one or more local devices of the external structure (e.g., and not global devices of the external structure) when a determination is made that a characteristic of the physical environment does not correspond to a preference level of a user. In some embodiments, computer system 600 transmits instructions to one or more global devices of the external structure (e.g., and not local devices of the external structure) when a determination is made that a characteristic of the physical environment does not correspond to a preference level of a user.

At FIG. 2B, computer system 600 displays an animation within volume user interface object 612 that corresponds to how the operation of the playback device is changing and computer system 600 displays an animation within brightness user interface object 614 that corresponds to how the operation of the set of one or more light devices are changing. Accordingly, at FIG. 2B, computer system 600 displays an animation of a flashing downward facing arrow within volume user interface object 612 to indicate that the volume level of the playback device is decreasing and computer system 600 displays an animation of a flashing upward facing arrow within brightness user interface object 614 to indicate that the brightness level of the set of one or more light devices is increasing. In some embodiments, computer system 600 displays volume user interface object 612 and brightness user interface object 614 with a background color. In examples where computer system 600 displays volume user interface object 612 and brightness user interface object 614 with a background color, computer system 600 animates the color of the background transitioning from a color that corresponds to a characteristic (e.g., noise or brightness) of the physical environment to a color that corresponds to the preference level of the user (e.g., computer system 600 changes the intensity, brightness, shading, and/or tinting of the background of volume user interface object 612 and/or brightness user interface object 614 to correspond to the preference level of the user). In some embodiments, computer system 600 displays an animation of a graphical element (e.g., a speaker glyph) within volume user interface object 612 to indicate that the volume level of the playback device is increasing (e.g., computer system 600 displays an animation of sound waves that progressively get bigger in size as emanating from the speaker glyph). In some embodiments, computer system 600 does not transmit instructions to an external display (e.g., a display that is external to computer system 600) that cause the external display to display volume user interface object 612 and brightness user interface object (e.g., volume user interface object 612 and brightness user interface object 614 are only displayed on display 604). In some embodiments, computer system 600 displays the animation of brightness user interface object 614 and/or volume user interface object 612 changing at a location on display 604 based on the position of the user (e.g., if the user is to the left of computer system 600, computer system 600 displays the animation of brightness user interface object 614 and/or volume user interface object 612 changing on the left portion of display 604).

At FIG. 2C, computer system 600 completes displaying the animation that results in the display of first user welcome user interface 608. At FIG. 2C, after computer system 600 completes displaying the animation that results in the display first user welcome user interface 608, computer system 600 ceases to display first user welcome user interface 608 and displays landing page user interface 618. As illustrated in FIG. 2C, landing page user interface 618 includes volume slider control 626 and brightness slider control 628. Volume slider control 626 corresponds to the playback device and brightness slider control 628 corresponds to the set of one or more light devices. In some embodiments, computer system 600 changes the appearance of volume slider control 626 and brightness slider control 628 based on detected changes to one or more characteristics of the physical environment. In some embodiments, computer system 600 does not change the appearance of volume slider control 626 and brightness slider control 628 based on detected changes to one or more characteristics of the physical environment.

The appearance of volume slider control 626 corresponds to the volume level of the playback device. At FIG. 2C, the volume level of the playback device is set to 50% of the maximum volume level of the playback device. Accordingly, as illustrated in FIG. 2C, computer system 600 displays half of volume slider control 626 as filled in to indicate that the volume level of the playback device is set to 50% of the maximum volume level of the playback device. Similar to the appearance of volume slider control 626, the appearance of background 618b corresponds to the volume level of the playback device. Accordingly, as illustrated in FIG. 2C, because the volume level of the playback device is set to 50% of the maximum volume level of the playback device, computer system 600 displays half of background 618b as filled in (e.g., as indicated by the hatching). In some embodiments, the color of background 618b corresponds to the volume level of the playback device (e.g., the higher the volume level of the playback device the more intense the color of background 618b is). In some embodiments, computer system 600 changes, in real time, the appearance of background 618b and volume slider control 626 based on changes to the volume level of the playback device changes.

FIG. 2D illustrates a second scenario where user 610 is the Kyle and the physical environment has a second set of characteristics. As explained above, FIG. 2D, can follow FIG. 2A.

At FIG. 2D, a determination is made that user 610 corresponds to the first user (e.g., Kyle). In response to detecting the presence of user 610 (e.g., detecting the presence of user 610 at FIG. 2A) and because a determination is made that user 610 corresponds to Kyle, computer system 600 displays first user welcome user interface 608. At FIG. 2D, as a part of displaying first user welcome user interface 608, computer system 600 animates first user welcome user interface 608 as gradually fading into display 604 over a period of time.

At FIG. 2D, the output of the playback device causes the physical environment to be at a noise level of 2 decibels (e.g., assuming, for ease of explanation, that there is a direct correlation between noise level of the play back and noise level in the physical environment). Further, at FIG. 2D, the output of the set of one or more light devices causes the physical environment to be at a brightness level of thirty lux (e.g., assuming, for ease of explanation, that there is a direct correlation between brightness level of the set of one or more light devices and brightness level in the physical environment). As discussed above, Kyle has a noise preference level of 25 decibels and Kyle has a brightness preference level of 20 lux. Accordingly, at FIG. 2D, the brightness level of the physical environment is greater than the brightness preference level of Kyle and the noise level of the physical environment is less than the noise preference level of Kyle (e.g., in contrast to FIG. 2B where the volume level of the physical environment is greater than the noise preference level of Kyle and the brightness level of the physical environment is less than the brightness preference level of Kyle).

At FIG. 2D, a determination is made that the noise level of the physical environment is less than the noise preference level of Kyle. At FIG. 2D, because a determination is made that the noise level of the physical environment is less than the noise preference level of Kyle, computer system 600 transmits instructions to the playback device that cause the playback device to increase the volume level of the playback device such that the noise level of the physical environment is equal to the noise preference level of Kyle. Further, at FIG. 2D, a determination is made that the brightness level of the physical environment is greater than the brightness preference level of Kyle. Because a determination is made that the brightness level of the physical environment is greater than the brightness preference level of Kyle, computer system 600 transmits instructions to the set of one or more light devices that that cause the set of one or more light devices to decrease the brightness level of the set of one or more light devices such that the brightness level of the physical environment is equal to the brightness preference level of Kyle.

At FIG. 2D, the relationship the characteristics of the physical environment (e.g., the brightness level and the noise level of the physical environment) and the user's preferences is the inverse of the relationship between the characteristics of the physical environment and the user's preference at FIG. 2B. Accordingly, at FIG. 2D, computer system 600 causes the playback device and the set of one or more light devices to perform the opposite operation than the operation of the playback device and the set of one or more light devices at FIG. 2B.

FIG. 2E illustrates a third scenario where user 610 is a second user (e.g., different from Kyle) and the physical environment has a third set of characteristics. As explained above, FIG. 2E can follow FIG. 2A.

At FIG. 2E, a determination is made that user 610 corresponds to a second user (e.g., a user named Jan, who is a different user than Kyle). In response to detecting the presence of user 610 and because a determination is made that user 610 corresponds to Jan, computer system 600 displays an animation of second user welcome user interface 630 as gradually fading into display 604 over a period of time (e.g., 3, 5, 10, 15, 20, 30, 45, or 60 seconds). As explained above, computer system 600 tailors the display of a welcome user interface based on which computer system 600 detects. At FIG. 2E, because computer system 600 detects the presence of the second user, computer system 600 tailors the appearance of the welcome user interface to the second user. Accordingly, as illustrated in FIG. 2E, second user welcome user interface 630 includes avatar user interface object 632 that is representative of Jan (e.g., avatar user interface object 632 includes the initials (“JA”) of Jan and/or includes a graphical representation (e.g., avatar and/or picture) of Jan) along with a salutation to Jan (e.g., “Hi, Jan”).

At FIG. 2E, the output of the playback device causes the physical environment to be at a noise level of two decibels (e.g., assuming, for ease of explanation, that there is a direct correlation between volume level of the playback device and noise level in the physical environment). Further, at FIG. 2E, the output of the set of one or more light devices causes the physical environment to be at a brightness level of thirty lux (e.g., assuming, for ease of explanation, that there is a direct correlation between the brightness level of the set of one or more light devices and the brightness level of the physical environment). As explained above, each respective user of the external structure has preference levels for various characteristics (e.g., noise, brightness, and/or temperature) of the physical environment. With respect to the noise level in the physical environment, Jan has a noise preference level of zero decibels. Further, with respect to the brightness level of the physical environment, Jan has a brightness preference level of ten lux.

At FIG. 2E, a determination is made that the noise level of the physical environment is greater than noise preference level of Jan. Because a determination is made that the noise level of the physical environment is greater than the noise preference level of Jan, computer system 600 transmits instructions to the playback device that that cause the playback device to decrease the volume level of the playback device such that the noise level of the physical environment is equal to the noise preference level of Kyle. Further, at FIG. 2E, a determination is made that the brightness level of the physical environment is greater than the brightness preference level of Jan. Because a determination is made that the brightness level of the physical environment is greater than the brightness preference level of Jan, computer system 600 transmits instructions to the set of one or more light devices that cause the set of one or more light devices to decrease the brightness level of the set of one or more light devices such that the brightness level of the physical environment is equal to the brightness preference level of Jan.

As explained above, computer system 600 displays an animation within volume user interface object 612 that corresponds to how the operation of the playback device is changing and computer system 600 displays an animation within brightness user interface object 614 that corresponds to how the operation of the set of one or more light devices is changing. Accordingly, at FIG. 2E, computer system 600 displays an animation of a downward facing blinking arrow within volume user interface object 612 to indicate that the volume level of the playback device is decreasing. Further, at FIG. 2E, computer system 600 displays an animation of a downward facing blinking arrow within brightness user interface object 614 to indicate that the brightness level of the set of one or more light devices is decreasing.

At FIG. 2E, computer system 600 detects input 605e directed at the display location of brightness user interface object 614. In some embodiments, input 605e is a gaze, long press (e.g., tap and hold), voice command, swipe input, tap input, rotation of rotatable input mechanism 616, pressing of rotatable input mechanism 616, and/or hand gesture. In some embodiments, computer system 600 displays different types of animations of volume user interface object 612 and brightness user interface object 614 changing for different users.

At FIG. 2F, computer system 600 completes displaying the animation that results in the display of second user welcome user interface 630. At FIG. 2F, after computer system 600 completes displaying the animation that results in the display second user welcome user interface 630, computer system 600 ceases to display second user welcome user interface 630 and displays landing page user interface 618. At FIG. 2F, the volume level of the playback device is set to 0% and the set of one or more light devices is operating at a brightness level of 10 lux. Accordingly, at FIG. 2F, because the volume level of the playback device is set to 0%, computer system 600 does not display any part of volume slider control 626 as filled in. Further, because the volume level of the playback device is set to 0%, computer system 600 does not display any portion of background 618b as filled in. At FIG. 2F, computer system 600 does not perform a respective operation in response to detecting input 605e. That is, brightness user interface object 614 (e.g., and volume user interface object 612) is not selectable.

At FIG. 2F, volume slider control 626 is the default control. Because volume slider control 626 is the default control, rotatable input mechanism 616 is automatically (e.g., without intervening user input) configured to control the volume level of the playback device. At FIG. 2F, computer system 600 detects input 605f that corresponds to a rotation of rotatable input mechanism 616. In some embodiments, input 605f is a gaze, long press (e.g., tap and hold), voice command, swipe input, tap input, rotation of rotatable input mechanism 616, pressing of rotatable input mechanism 616, and/or hand gesture. In some embodiments, landing page user interface 618 includes a default control that is a media playback control. In examples where the media playback control is the default control, rotatable input mechanism 616 is configured to control the playback status of the playback device (e.g., pause the playback of a media item, initiate the playback of a media time, skip to new media item, or rewind the playback of a media item) when computer system 600 initially displays landing page user interface 618. In examples where the media playback control is the default control, computer system 600 displays background 618b with an appearance that is based on a media item that the playback device is configured to playback.

As illustrated in FIG. 2G, in response to detecting input 605f, computer system 600 ceases to display landing page user interface 618 and displays volume level user interface 640. Further, at FIG. 2G, in response to detecting input 605f, computer system 600 transmits instructions to the playback device that that cause the playback device to increase the volume level of the playback device from 0% to 40% (e.g., 40% of the maximum volume level). Accordingly, at FIG. 2G, the volume level of the playback device is set to 40%.

As illustrated in FIG. 2G, because the volume level of the playback device is set to 40%, computer system 600 displays 40% of background 640b as filled in to indicate the volume level of the playback device. Further, as illustrated in FIG. 2G, because the volume level of the playback device is set to 40%, computer system 600 displays 40% of volume slider control 626 as filled in. At FIG. 2G, computer system 600 detects input 605g that corresponds to a rotation of rotatable input mechanism 616. In some embodiments, computer system 600 transmits instructions to the playback device that that cause the playback device to adjust the volume level of the playback device based on the detected direction of the rotation of rotatable input mechanism 616 (e.g., the instructions cause the playback device to increase the volume level of the playback device when a determination is made that rotatable input mechanism 616 is rotated in a clockwise direction and the instructions cause the playback device to decrease the volume level of the playback device when a determination that rotatable input mechanism 616 is rotated in a counter-clockwise direction) . . . . In some embodiments, input 605g is a gaze, long press (e.g., tap and hold), voice command, swipe input, tap input, rotation of rotatable input mechanism 616, pressing of rotatable input mechanism 616, and/or hand gesture. In some embodiments, computer system 600 displays background 640b with an appearance that corresponds to a media item that the playback device is configured to playback.

At FIG. 2H, in response to detecting input 605g, computer system 600 transmits instructions to the playback device that cause the playback device to that increase the volume level of the playback device from 40% to 75% (e.g., 75% of the maximum volume level). Accordingly, at FIG. 2G, the volume level of the playback device is set to 75%. As illustrated in FIG. 2H, because the volume level of the playback device is set to 75%, computer system 600 displays 75% of background 640b as filled in to indicate the volume level of the playback device. Further, as illustrated in FIG. 2H, because the volume level of the playback device is set to 75%, computer system 600 displays 75% of volume slider control 626 as filled in.

At FIG. 2I, a determination is made that a predetermined amount of time (e.g., 5, 10 20, 30, 45, or 60 seconds) has elapsed since computer system 600 detected an input (e.g., since computer system 600 detected input 605g). As illustrated in FIG. 2I, because a determination is made that a predetermined amount of time has elapsed since computer system 600 detected an input, computer system 600 ceases to display volume level user interface 640 and displays landing page user interface 618. At FIG. 2I, rotatable input mechanism 616 remains configured to control the playback device. At FIG. 2I, computer system 600 detects input 605i that corresponds to selection of brightness slider control 628. In some embodiments, input 605i is a gaze, long press (e.g., tap and hold), voice command, swipe input, tap input, rotation of rotatable input mechanism 616, pressing of rotatable input mechanism 616, and/or hand gesture.

At FIG. 2J, in response to detecting input 605i, computer system 600 unconfigures rotatable input mechanism 616 from controlling the playback device and configures rotatable input mechanism 616 to control the set of one or more light devices. Further, as illustrated in FIG. 2J, in response to detecting input 605i, computer system 600 ceases to display landing page user interface 618 and displays brightness level user interface 644. As illustrated in FIG. 2J, brightness level user interface 644 includes brightness slider control 628 and background 644b. Computer system 600 fills in background 644b based on the brightness level of the set of one or more light devices. Computer system 600 displays background 644b with a different appearance than background 618b. At FIG. 2J, the brightness level of the set of one or more light devices is set to 10 lux which is 40% of the maximum brightness level of the light devices. Accordingly, as illustrated in FIG. 2J, computer system 600 displays 40% of background 644b as filled in. At FIG. 2J, computer system 600 detects input 605j that corresponds to rotation of rotatable input mechanism 616. In some embodiments, input 605j corresponds to tap input, a swipe input, a long press (e.g., tap and hold), a voice command, hand gesture and/or a depression of rotatable input mechanism 616.

At FIG. 2K, in response to detecting input 605j, computer system 600 transmits instructions to that set of one or more light devices that cause the set of one or more light devices to decrease the brightness level of the set of one or more light devices from 40% to 15%. As illustrated in FIG. 2K, because the brightness level of the set of one or more light devices is set to 15%, computer system 600 fills in 15% of background 644b. In some embodiments, computer system 600 transmits instructions to the set one or more light devices that that cause the set of one or more light devices to adjust the brightness level of the set of one or more light devices based on the detected direction of the rotation of rotatable input mechanism 616 (e.g., the instructions cause the set of one or more light devices to increase the brightness level of the set of one or more light devices when a determination is made that rotatable input mechanism 616 is rotated in a clockwise direction and the instructions cause the set of one or more light devices to decrease the brightness level of the set of one or more light devices when a determination is made that rotatable input mechanism 616 is rotated in a counter-clockwise direction.

FIGS. 3A-3B is a flow diagram illustrating a method (e.g., process 700) for modifying the operation of a device in accordance with some examples. Some operations in process 700 are, optionally, combined, the orders of some operations are, optionally, changed, and some operations are, optionally, omitted.

As described below, process 700 provides an intuitive way for modifying the operation of a device. Process 700 reduces the cognitive burden on a user for modifying the operation a device, thereby creating a more efficient human-machine interface. For battery-operated computing devices, enabling a user to modify the operation of a device faster and more efficiently conserves power and increases the time between battery charges.

In some embodiments, process 700 is performed at a computer system (e.g., 600) that is in communication with a display component (e.g., 604) (e.g., a display screen and/or a touch-sensitive display) and a first device (e.g., one or more light devices and/or playback devices as described above at FIGS. 2A-2E) (e.g., an external device, an internal device, a fan, a thermostat, a window, a set of blinds, a speaker, a microphone, and/or a door). In some embodiments, the computer system is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the computer system is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras).

While the first device (e.g., one or more light devices and/or playback devices as described above at FIGS. 2A-2E) is providing (e.g., outputting (e.g., moving, blowing, adjusting, has moved to, has blown, and/or has adjusted)) first output (e.g., a zero output or a non-zero output), the computer system detects (702) a presence of a user (e.g., 610) (e.g., detecting a body part of the user near a predetermined location, the computer system, and/or a portion of the computer system; detecting movement of the user, and/or detecting a device and/or computer system that is associated with the user).

In response to (704) detecting the presence of the user (e.g., 610) and in accordance with a determination that a value of a setting corresponding to the user (e.g., 610) (e.g., a setting customized for the user, a setting automatically determined for the user, and/or a setting set by the user) (e.g., temperature, light, volume, seating heating, window tint, fan output (e.g., speed and/or temperature)) is a first value and a value of a characteristic of an environment (e.g., the physical environment, the environment inside of the computer system and/or inside a portion of the computer, and/or the environment outside of the computer system and/or outside a portion of the computer system) (e.g., temperature, light, and/or sound) is a second value, the computer system (e.g., 600) causes (706) the first device (e.g., one or more light devices and/or playback devices as described above at FIGS. 2A-2E) to provide second output that is different from the first output (e.g., as described above at FIGS. 2B, 2D, and 2E).

In response to (704) detecting the presence of the user (e.g., 610) and in accordance with a determination that the value of the setting corresponding to the user (e.g., 610) is a third value, different from the first value, and the value of the characteristic of the environment is the second value, the computer system (e.g., 600) causes (708) the first device (e.g., one or more light devices and/or playback devices as described above at FIGS. 2A-2E) to provide third output that is different from the second output and the first output (e.g., as described above at FIGS. 2B, 2D, and 2E).

In response to (704) detecting the presence of the user (e.g., 610) and in accordance with a determination that the value of the setting corresponding to the user (e.g., 610) is the first value and the value of the characteristic of the environment is a fourth value, different from the second value, the computer system (e.g., 600) causes (710) the first device (e.g., one or more light devices and/or playback devices as described above at FIGS. 2A-2E) to provide fourth output that is different from the third output, the second output, and the first output (e.g., as described above at FIGS. 2B, 2D, and 2E).

In response to (704) detecting the presence of the user (e.g., 610) and in accordance with a determination that the value of the setting corresponding to the user (e.g., 610) is the third value and the value of the characteristic of the environment is the fourth value, the computer system (e.g., 600) causes (712) the first device (e.g., one or more light devices and/or playback devices as described above at FIGS. 2A-2E) to provide fifth output that is different from the fourth output, the third output, the second output, and the first output (e.g., as described above at FIGS. 2B, 2D, and 2E). Causing the first device to provide different output depending on the value of the setting corresponding to the user and the value of the characteristic of the environment allows for the computer system to reflect and/or control a device based on the value of setting corresponding to the user and the value of the characteristic of the environment, thereby reducing the number of inputs needed to perform an operation, providing additional control options without cluttering the user interface with additional displayed controls, and/or performing an operation when a set of conditions has been met without requiring further user input.

In some embodiments, in response to detecting the presence of the user (e.g., 610) and in accordance with a determination that the value of the setting corresponding to the user is the first value and the value of the characteristic of the environment is the second value (e.g., as described above at FIGS. 2B, 2D and 2E), the computer system (e.g., 600) displays, via the display component (e.g., 604), an indication (e.g., animation of 612 and/or 614) (e.g., a graphical user-interface element, a graphic, one or more alphanumerical characters, and/or an animation) that the first device (e.g., one or more light devices and/or playback devices as described above at FIGS. 2A-2E) is being transitioned from providing the first output to providing the second output. In some embodiments, in response to detecting the presence of the user and in accordance with a determination that the value of the setting corresponding to the user is a third value and the value of the characteristic of the environment is the second value (e.g., as described above at FIGS. 2B, 2D and 2E), the computer system displays, via the display component, an indication that the first device is being transitioned from providing the first output to providing the third output (e.g., animation of 612 and/or 614) (and, In some embodiments, without displaying the indication that the first device is being transitioned from providing the first output to providing the second output). In some embodiments, in response to detecting the presence of the user and in accordance with a determination that the value of the setting corresponding to the user is the first value and the value of the characteristic of the environment is the fourth value (e.g., as described above at FIGS. 2B, 2D and 2E), the computer system displays, via the display component (e.g., 604), an indication that the first device is being transitioned from providing the first output to providing the fourth output (e.g., animation of 612 and/or 614) (and, In some embodiments, without displaying the indication that the first device is being transitioned from providing the first output to providing the second output and/or without displaying the indication that the first device is being transitioned from providing the first output to providing the third output). In some embodiments, in response to detecting the presence of the user and in accordance with a determination that the value of the setting corresponding to the user is the third value and the value of the characteristic of the environment is the fourth value (e.g., as described above at FIGS. 2B, 2D and 2E), the computer system displays, via the display component, an indication that the first device is being transitioned from providing the first output to providing the fifth output (e.g., animation of 612 and/or 614) (and, In some embodiments, without displaying the indication that the first device is being transitioned from providing the first output to providing the second output, without displaying the indication that the first device is being transitioned from providing the first output to providing the third output, and/or without displaying the indication that the first device is being transitioned from providing the first output to providing the fifth output). Displaying different indications depending on the value of the setting corresponding to the user and the value of the characteristic of the environment allows for the computer system to reflect the value of setting corresponding to the user and the value of the characteristic of the environment, thereby reducing the number of inputs needed to perform an operation, providing additional control options without cluttering the user interface with additional displayed controls, and/or performing an operation when a set of conditions has been met without requiring further user input.

In some embodiments, the computer system (e.g., 600) is in communication with a second display component (e.g., 604). In some embodiments, in response to detecting a presence of the user (e.g., 610) is detected within a first predetermined distance from the display component (e.g., and not within the first predetermined distance from the second display component) and in accordance with a determination that the value of the setting corresponding to the user is the first value and the value of the characteristic of the environment is the second value, the computer system forgoes displaying, via the second display component, the indication that the first device (e.g., one or more light devices and/or playback devices as described above at FIGS. 2A-2E) is being transitioned from providing the first output to providing the second output (and, In some embodiments, the computer system displays, via the display component, the indication that the first device is being transitioned from providing the first output to providing the second output). In some embodiments, in response to detecting the presence of the user is detected within the first predetermined distance from the display component and in accordance with a determination that the value of the setting corresponding to the user is a third value and the value of the characteristic of the environment is the second value, the computer system forgoes displaying, via the second display component, the indication that the first device is being transitioned from providing the first output to providing the third output (and, In some embodiments, the computer system displays, via the display component, the indication that the first device is being transitioned from providing the first output to providing the third output). In some embodiments, in response to detecting the presence of the user is detected within the first predetermined distance from the display component and in accordance with a determination that the value of the setting corresponding to the user is the first value and the value of the characteristic of the environment is the fourth value, the computer system forgoes displaying, via the second display component, the indication that the first device is being transitioned from providing the first output to providing the fourth output (and, In some embodiments, the computer system displays, via the display component, the indication that the first device is being transitioned from providing the first output to providing the fourth output). In some embodiments, in response to detecting the presence of the user is detected within the first predetermined distance from the display component and in accordance with a determination that the value of the setting corresponding to the user is the third value and the value of the characteristic of the environment is the fourth value, the computer system forgoes displaying, via the second display component, the indication that the first device is being transitioned from providing the first output to providing the fifth output (and, In some embodiments, the computer system displays, via the display component, the indication that the first device is being transitioned from providing the first output to providing the fifth output). In some embodiments, in response to detecting the presence of the user is detected within the first predetermined distance from the second display component (e.g., and not within the first predetermined distance from the display component) and in accordance with a determination that the value of the setting corresponding to the user is the first value and the value of the characteristic of the environment is the second value, the computer system displays, via the second display component, the indication that the first device is being transitioned from providing the first output to providing the second output (and, In some embodiments, the computer system forgoes displaying, via the display component, the indication that the first device is being transitioned from providing the first output to providing the second output). In some embodiments, in response to detecting the presence of the user is detected within the first predetermined distance from the second display component and in accordance with a determination that the value of the setting corresponding to the user is a third value and the value of the characteristic of the environment is the second value, the computer system displays, via the second display component, the indication that the first device is being transitioned from providing the first output to providing the third output (and, In some embodiments, the computer system forgoes displaying, via the display component, the indication that the first device is being transitioned from providing the first output to providing the third output). In some embodiments, in response to detecting the presence of the user is detected within the first predetermined distance from the second display component and in accordance with a determination that the value of the setting corresponding to the user is the first value and the value of the characteristic of the environment is the fourth value, the computer system displays, via the second display component, the indication that the first device is being transitioned from providing the first output to providing the fourth output (and, In some embodiments, the computer system forgoes displaying, via the display component, the indication that the first device is being transitioned from providing the first output to providing the fourth output). In some embodiments, in response to detecting the presence of the user is detected within the first predetermined distance from the second display component and in accordance with a determination that the value of the setting corresponding to the user is the third value and the value of the characteristic of the environment is the fourth value, the computer system displays, via the second display component, the indication that the first device is being transitioned from providing the first output to providing the fifth output (and, In some embodiments, the computer system forgoes displaying, via the display component, the indication that the first device is being transitioned from providing the first output to providing the fifth output). Deciding whether or not to display an indication that the first device is being transitioned from providing different output when prescribed conditions are met allows the computer system to automatically display the indication on via a display component of which the presence of the user is detected within the first predetermined distance without displaying the indication via a display component of which the presence of the user is not detected within the first predetermined distance, thereby providing additional control options without cluttering the user interface with additional displayed controls.

In some embodiments, the setting is a first setting. In some embodiments, in response to detecting the presence of the user (610) and in accordance with a determination that a value of a second setting, different from the first setting, is a sixth value and the value of a second characteristic (e.g., the same characteristic as the characteristic or a different characteristic) of the environment is the second value, the computer system causes a second device to provide sixth output. In some embodiments, the second device is different from the first device. In some embodiments, the output of the device changes based on a different device, the same environmental characteristic(s), and the same setting; the same device, different environmental characteristic(s), and the same setting, or the same device and environmental characteristic(s) but a different setting. In some embodiments, in response to detecting the presence of the user (610) and in accordance with a determination that the value of the second setting is the sixth value and the value of the second characteristic of the environment is the second value, wherein the seventh value that is different from the sixth value, the computer system causes the second device to provide seventh output that is different from the sixth output. In some embodiments, the second device is a local device (e.g., a device associated with one or more areas of the computer system) while the first device is a global device (e.g., a device associated with (e.g., programmatically associated with, associated with a same location and/or side of a space, assigned to, corresponds to, included in, and/or identified based on) more areas than the areas of the computer system that a local device is associated with, a device associated with all areas of the computer system, and/or a device associated with the areas that a local device is associated with and areas that the local device is not associated with) and/or vice-versa.

In some embodiments, in accordance with a determination that the value of the second setting (and, In some embodiments, a setting that is different from the first setting) is the sixth value and the value of the second characteristic of the environment is the second value, the computer system displays, via the display component (e.g., 604), the indication that the second device is being transitioned from providing a respective output to providing the sixth output (e.g., animation of 612 and/or 614). In some embodiments, in accordance with a determination that the value of the second setting is the sixth value and the value of the second characteristic of the environment is the second value, the computer system displays, via the display component, the indication that the second device is being transitioned from providing the respective output to providing the seventh output (e.g., animation of 612 and/or 614). In some embodiments, the indication that the second device is being transitioned is displayed concurrently with the indication that the first device is being transitioned via the same display component and/or on the same or different displays or on separate or different display components and/or on separate displays. Causing the second device to provide different output depending on the value of the second setting corresponding to the user and the value of the second characteristic of the environment allows for the computer system to reflect the value of a different setting corresponding to the user and the value of the second characteristic (e.g., a different characteristic from the characteristic) of the environment, thereby reducing the number of inputs needed to perform an operation, providing additional control options without cluttering the user interface with additional displayed controls, and/or performing an operation when a set of conditions has been met without requiring further user input.

In some embodiments, in response to detecting the presence of the user (e.g., 610 and in accordance with a determination that the value of the setting corresponding to the user is the first value and the value of the characteristic of the environment is the second value, the computer system displays, via the display component (e.g., 604), an indication (e.g., avatar, name, identifier, text, and/or visual representation) of an identity of the user (e.g., 620) concurrently with the indication that the first device (e.g., one or more light devices and/or playback devices as described above at FIGS. 2A-2E) is being transitioned from providing the first output to providing the second output. In some embodiments, the indication of the identity of the user is displayed while an animation is displayed with an indication of how the output of the first device is changing, how the environment is changing, and/or how the output of the first device is changing relative to the environment changing. In some embodiments, the indication of the identity of the user is based on the identity of the user such that a different user causes a different indication to be displayed. In some embodiments, in response to detecting the presence of the user and in accordance with a determination that the value of the setting corresponding to the user is a third value and the value of the characteristic of the environment is the second value, the computer system displays, via the display component, the indication of the identity of the user concurrently with the indication that the first device is being transitioned from providing the first output to providing the third output. In some embodiments, in response to detecting the presence of the user and in accordance with a determination that the value of the setting corresponding to the user is the first value and the value of the characteristic of the environment is the fourth value, the computer system displays, via the display component, the indication of the identity of the user concurrently with the indication that the first device is being transitioned from providing the first output to providing the fourth output. In some embodiments, in response to detecting the presence of the user and in accordance with a determination that the value of the setting corresponding to the user is the third value and the value of the characteristic of the environment is the fourth value, the computer system displays, via the display component, the indication of the identity of the user concurrently with the indication that the first device is being transitioned from providing the first output to providing the fifth output. Displaying the identity of the user concurrently with the indication that the first device is being transitioned when prescribed conditions are met allows the computer system to automatically provide feedback to a user about why, on what basis, and/or how output of the first device is changing, which informs the user about the underlying processes of devices and/or the computer system, thereby performing an operation when a set of conditions has been met without requiring further user input and/or providing improved feedback.

In some embodiments, in accordance with a determination that a first set of criteria is met, the animation includes a first property (e.g., color, brightness, shape, and/or size) (e.g., 612 at FIG. 2B, 2D and/or 2E). In some embodiments, the first set of criteria includes a criterion that is met when a difference between the second output and the first output exceeds a threshold. In some embodiments, in accordance with a determination that a second set of criteria is met, the animation includes a second property (e.g., 612 at FIG. 2B, 2D and/or 2E) (e.g., more and/or less color, brighter, etc.) different from the first property (and does not include the first property). In some embodiments, the second set of criteria includes a criterion that is met when a difference between the second output and the first output exceeds a second threshold different from the threshold. In some embodiments, the second set of criteria includes a criterion that is met when a difference between the second output and the first output does not exceed the threshold. Displaying an animation that has different properties when prescribed conditions are met allows the computer system to provide intelligent feedback to the user concerning the underlying processes of devices and/or the computer system and the value of the characteristic of the environment, thereby reducing the number of inputs needed to perform an operation, providing additional control options without cluttering the user interface with additional displayed controls, and/or performing an operation when a set of conditions has been met without requiring further user input.

In some embodiments, while the first device (e.g., one or more light devices and/or playback devices as described above at FIGS. 2A-2E) is providing the first output, the computer system detects a presence of a second user (e.g., as described above at FIG. 2E) different from the user (e.g., 610). In some embodiments, in response to detecting the presence of the second user and in accordance with a determination that the value of the setting corresponding to the second user is a first respective value, different from the first value, and the value of the characteristic of the environment is the second value, the computer system causes the first device to provide output that is different from the second output (e.g., as described above at FIG. 2E) (and, In some embodiments, different from the first output, third output, fourth output, and fifth output). In some embodiments, in response to detecting the presence of the second user and in accordance with a determination that the value of the setting corresponding to the second user is a second respective value, different from the third value, and the value of the characteristic of the environment is the second value, the computer system causes the first device to provide output that is different from the third output (and, In some embodiments, different from the first output, second output, fourth output, and fifth output) (e.g., as described above at FIG. 2E). In some embodiments, in response to detecting the presence of the second user and in accordance with a determination that the value of the setting corresponding to the second user is the first respective value and the value of the characteristic of the environment is the fourth value, the computer system causes the first device to provide output that is different from the fourth output (and, In some embodiments, different from the first output, second output, third output, and fifth output) (and, In some embodiments, different from the output that is different from the second output) (e.g., as described above at FIG. 2E). In some embodiments, in response to detecting the presence of the second user and in accordance with a determination that the value of the setting corresponding to the user is the third value and the value of the characteristic of the environment is the fourth value, the computer system causes the first device to provide output that is different from the fifth output (e.g., as described above at FIG. 2E) (and, In some embodiments, different from the first output, second output, third output, and fourth output) (and, In some embodiments, different from the output that is different from the third output). Causing the first device to provide different output depending on the value of the setting corresponding to the second user and the value of the characteristic of the environment allows for the computer system to automatically reflect and/or control a device based on the value of setting corresponding to the second user and the value of the characteristic of the environment differently than the computer system would reflect and/or control the device because the settings for the second user are set differently than the settings for the user (e.g., first user), thereby reducing the number of inputs needed to perform an operation, providing additional control options without cluttering the user interface with additional displayed controls, and/or performing an operation when a set of conditions has been met without requiring further user input.

In some embodiments, detecting the presence of the user (e.g., 610) includes detecting that a user is in a respective position (e.g., as described above at FIG. 2A) (e.g., a particular position and/or a specific position) (e.g., sitting down, standing up, sitting down at a particular location, sitting down in a particular seat, and/or kneeling at a particular location). Causing the first device to provide different output depending on the value of the setting corresponding to the user and the value of the characteristic of the environment in response to detecting that a user is in a respective position allows for the computer system to reflect and/or control a device based on the value of setting corresponding to the user and the value of the characteristic of the environment in a controlled manner that is dependent on the user being in the respective position, thereby reducing the number of inputs needed to perform an operation, providing additional control options without cluttering the user interface with additional displayed controls, and/or performing an operation when a set of conditions has been met without requiring further user input.

In some embodiments, detecting presence of the user (e.g., 610) includes detecting a device (e.g., as described above at FIG. 2A) (e.g., a wearable device, a fitness tracking device, and/or a smartwatch). Causing the first device to provide different output depending on the value of the setting corresponding to the user and the value of the characteristic of the environment in response to detecting a device allows for the computer system to reflect and/or control a device based on the value of setting corresponding to the user and the value of the characteristic of the environment in a controlled manner that is dependent on the device being detected, thereby reducing the number of inputs needed to perform an operation, providing additional control options without cluttering the user interface with additional displayed controls, and/or performing an operation when a set of conditions has been met without requiring further user input.

In some embodiments, detecting presence of the user (e.g., 610) includes detecting that a body part (e.g., a hand, finger, a wrist, an arm, and/or a foot) of the user is within a predetermined distance (e.g., 0.1-4 meters) from a display (e.g., 604) (e.g., as described above at FIG. 2A) (e.g., the display component and/or another display and/or display component). In some embodiments, detecting presence of the user includes detecting an intent to control the display (e.g., a gaze, a body part, and/or a gesture that is directed to and/or within the predetermined distance and/or is near the display). Causing the first device to provide different output depending on the value of the setting corresponding to the user and the value of the characteristic of the environment in response to detecting a body part of the user being within a predetermined distance from the display allows for the computer system to reflect and/or control a device based on the value of setting corresponding to the user and the value of the characteristic of the environment in a controlled manner that is dependent on the body part of the user being within the predetermined distance from the display being detected, thereby reducing the number of inputs needed to perform an operation, providing additional control options without cluttering the user interface with additional displayed controls, and/or performing an operation when a set of conditions has been met without requiring further user input.

In some embodiments, the first device (e.g., one or more light devices and/or playback devices as described above at FIGS. 2A-2E) is a local device (e.g., as described above at FIG. 2B) (e.g., device that is associated with same side that is associated with the display) (e.g., screen with the dial) (e.g., distance from a first display components causes a first set of devices to be change without causing a second set of device to be changed and/or the set of devices that are changed because of a distance between a display component and a user and/or a computer system).

In some embodiments, the first device (e.g., one or more light devices and/or playback devices as described above at FIGS. 2A-2E) is a global device (e.g., as described above at FIG. 2B) (e.g., distance from the first display components causes the first set of devices to be change and the second set of devices to be changed and/or the set of devices that are changed irrespective of a distance between a display component and a user and/or a computer system).

Note that details of the processes described above with respect to process 700 (e.g., FIGS. 3A-3B) are also applicable in an analogous manner to other methods described herein. For example, process 1000 optionally includes one or more of the characteristics of the various methods described above with reference to process 700. For example, an indication of how an output of a device is changing can be displayed using the techniques described below in relation to 700 on a device that is caused to provide the output using one or more techniques described above in relation to 1000. For brevity, these details are not repeated below.

FIG. 4 is a flow diagram illustrating a method (e.g., process 800) for displaying an animation representing a change in an operation of a device in accordance with some examples. Some operations in process 800 are, optionally, combined, the orders of some operations are, optionally, changed, and some operations are, optionally, omitted.

As described below, process 800 provides an intuitive way for displaying an animation representing a change in an operation of a device. Process 800 reduces the cognitive burden on a user for displaying an animation representing a change in an operation of a device, thereby creating a more efficient human-machine interface. For battery-operated computing devices, enabling a user to display an animation representing a change in an operation of a device faster and more efficiently conserves power and increases the time between battery charges.

In some embodiments, process 800 is performed at a computer system (e.g., 600) that is in communication with a display component (e.g., 604) (e.g., a display screen and/or a touch-sensitive display). In some embodiments, the computer system is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the computer system is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras). In some embodiments, the computer system is in communication with a first device (e.g., an external device, an internal device, a fan, a thermostat, a window, a set of blinds, a speaker, a microphone, and/or a door).

The computer system detects (802) a presence of a first user (e.g., 610) (e.g., detecting a body part of the user near a predetermined location, the computer system, and/or a portion of the computer system; detecting movement of the user, and/or detecting a device and/or computer system that is associated with the user).

In response to detecting the presence of the first user, the computer system displays (804), via the display component (e.g., 604), a first user interface (e.g., 608) that includes (and/or displaying, via the display component, a first animation that includes): (806) a first indication of how output of a first device (e.g., one or more light devices and/or playback devices as described above at FIGS. 2A-2E) is changing based on detecting the presence of the first user (e.g., animation of 612 and/or 614); and a (808) second indication of how output of a second device (e.g., different from the first device) is changing based on detecting the presence of the first user (e.g., 610) (e.g., animation of 612 and/or 614), wherein the first indication is different from the second indication. In some embodiments, the output of the first device is changed to match a preference and/or setting of the first user in response to detecting presence of the first user. In some embodiments, the output of the first device is changed to match a default setting for a user in response to detecting presence of the first user. In some embodiments, the output of the first device is changed similarly to as described in process 700. In some embodiments, the output of the second device is changed to match a preference and/or setting of the first user in response to detecting presence of the first user. In some embodiments, the output of the second device is changed to match a default setting for a user in response to detecting presence of the first user. In some embodiments, the output of the second device is changed similarly to as described in process 700.

After displaying the first user interface (e.g., 608) (and, In some embodiments, after ceasing to display the first user interface), the computer system displays (810), via the display component (e.g., 604), a second user interface (e.g., 618) that does not include the first indication and the second indication (e.g., one or more light devices and/or playback devices as described above at FIGS. 2A-2E) and includes: (812) a first control (e.g., 626 and/or 628), wherein the first control includes an indication of a value of a first setting corresponding to the first device (e.g., one or more light devices and/or playback devices as described above at FIGS. 2A-2E) (e.g., as described above at FIG. 2C) (e.g., and the first user) and a (814) second control (e.g., 626 and/or 628), wherein the second control includes an indication of a value of a second setting corresponding to the second device (e.g., one or more light devices and/or playback devices as described above at FIGS. 2A-2E) (e.g., as described above at FIG. 2C) (e.g., and the first user). In some embodiments, the first control is selectable to change the value of the first setting. In some embodiments, the second user interface is displayed in response to the first device and/or the second device finishing changing. In some embodiments, the second user interface is displayed in response to the first user interface having been displayed for a predefined period of time. In some embodiments, the second control is selectable to change the value of the second setting. In some embodiments, the first user interface does not include the first control and the second control. Displaying indications of how output of devices are changing in response to detecting the presence of the user allows for the computer system to reflect when the presence of the user is detected, thereby reducing the number of inputs needed to perform an operation, providing additional control options without cluttering the user interface with additional displayed controls, and/or performing an operation when a set of conditions has been met without requiring further user input. Changing the output of devices based on detecting the presence of the user allows for the computer system to react to detecting the presence of the user, thereby reducing the number of inputs needed to perform an operation, providing additional control options without cluttering the user interface with additional displayed controls, and/or performing an operation when a set of conditions has been met without requiring further user input. Displaying the first control and the second control after displaying the first user interface allows for a user to see a current value of settings after being changed, thereby providing improved visual feedback to the user and/or performing an operation when a set of conditions has been met without requiring further user input.

In some embodiments, the computer system detects a presence of a second user (e.g., 610) (e.g., without detecting the presence of the first user). In some embodiments, in response to detecting the presence of the second user (e.g., as described above at FIG. 2E), the computer system displays, via the display component (e.g., 604), a third user interface (e.g., 630) that includes: a third indication of how output of the first device (e.g., one or more light devices and/or playback devices as described above at FIGS. 2A-2E) is changing (e.g., animation of 612 and/or 614 at FIG. 2C) based on detecting presence of the second use and a fourth indication of how output of the second device (e.g., one or more light devices and/or playback devices as described above at FIGS. 2A-2E) (e.g., different from the first device) is changing (e.g., animation of 612 and/or 614 at FIG. 2C) based on detecting presence of the second user, wherein the third indication is different from the first indication, the second indication, and the fourth indication, and wherein the fourth indication is different from the first indication, the second indication, and the third indication. In some embodiments, after displaying the third user interface, the computer system displays, via the display component (e.g., 604), a fourth user interface (e.g., 618) that does not include the third indication and the fourth indication and includes: the first control (e.g., 626 and/or 628), wherein the first control includes an indication of a second value of the first setting corresponding to the first device (e.g., a value that is different from the value of the first setting corresponding to the first device) that is different from the indication of the value of the first setting corresponding to the first device and a second control (e.g., 626 and/or 628), wherein the second control includes an indication of a second value corresponds to the second setting corresponding to the second device (e.g., a value that is different from the value of the second setting corresponding to the second device) that is different from the indication of the value of the second setting corresponding to the second device (e.g., and the first user). Displaying different indications depending on which user is detected allows for the computer system to cater to a particular user that is detected, thereby providing improved visual feedback to the user, reducing the number of inputs needed to perform an operation, providing additional control options without cluttering the user interface with additional displayed controls, and/or performing an operation when a set of conditions has been met without requiring further user input.

In some embodiments, the computer system (e.g., 600) is in communication with a first display component (e.g., 604) and a second display component (e.g., 604). In some embodiments, in response to detecting the presence of the first user and in accordance with a determination that the first user is detected closer to the first display than the second display component, the first user interface (e.g., 608) and the second user interface (e.g., 618) is displayed via the first display component and not the second display component. In some embodiments, the determination that the first user is detected closer to the first display than the second display includes a determination that the first user is detected within a predetermined distance (as discussed above with respect to process 700) of the first display. In some embodiments, in response to detecting the presence of the first user and in accordance with a determination that the first user is detected closer to the second display component than the first display component, the first user interface and the second user interface is displayed via the second display and not the first display. In some embodiments, the determination that the first user is detected closer to the second display than the first display includes a determination that the first user is detected within the predetermined distance of the second display. Displaying the first user interface and the second user interface on a display that is closer to where the first user is detected allows for the computer system to change is operations based on where the first user is located and attempt to display the user interfaces in a location best viewable by the first user, thereby providing improved visual feedback to the user, reducing the number of inputs needed to perform an operation, providing additional control options without cluttering the user interface with additional displayed controls, and/or performing an operation when a set of conditions has been met without requiring further user input.

In some embodiments, the first control (e.g., 626 and/or 628) is displayed with a first visual appearance after displaying the first user interface (e.g., 608). In some embodiments, while displaying the first control with the first visual appearance, the computer system detects a change in a physical environment. In some embodiments, in response to detecting the change in the physical environment and in accordance with a determination that the change in the physical environment is a first change, the computer system changes the first control to be displayed with a second visual appearance instead of the first visual appearance (e.g., as described above at FIG. 2C), wherein the second visual appearance is different from the first visual appearance. In some embodiments, in response to detecting the change in the physical environment and in accordance with a determination that the change in the physical environment is a second change that is different from the first change, the computer system changes the first control to be displayed with a third visual appearance instead of the first visual appearance (e.g., as described above at FIG. 2C), wherein the third visual appearance is different from the first visual appearance and the second visual appearance. Changing the first control in accordance with a determination based on the change in the physical environment allows for the computer system to develop to changing environmental conditions without user input, thereby providing improved visual feedback to the user, reducing the number of inputs needed to perform an operation, providing additional control options without cluttering the user interface with additional displayed controls, and/or performing an operation when a set of conditions has been met without requiring further user input.

In some embodiments, in response to detecting the change in the physical environment, the computer system forgoes changing a visual appearance of the second control (e.g., 626 and/or 628) (e.g., as described above at FIG. 2C) (e.g., irrespective of the change in the physical environment). Forgoing changing the visual appearance of the second control while changing the first control in response to detecting the change in the physical environment allows for the computer system to only have certain controls that change in response to detecting the change in the physical environment, thereby reducing the number of inputs needed to perform an operation, providing additional control options without cluttering the user interface with additional displayed controls, and/or performing an operation when a set of conditions has been met without requiring further user input.

In some embodiments, the first user interface (e.g., 608) does not include a user interface element (e.g., the first control or a different user-interface element) corresponding to the first control (e.g., 626 and/or 628) (In some embodiments, a control, where a user has set it not to change with changes in the environment). In some embodiments, the first user interface does not include a user interface element (e.g., the second control or a different user-interface element) corresponding to the second control (e.g., 626 and/or 628). Not including the user interface element that corresponds to the first control and the user interface element that does not correspond to the second controls allows the computer system to de-clutter the user interface and preserves screen real estate, thereby providing improved feedback (e.g., visual feedback) to the user.

In some embodiments, after detecting the presence of the first user (e.g., 610) and in accordance with a determination that the presence of the user is not detected for a predetermined period of time, the computer system ceases to display visual content via the display component (e.g., 604) (e.g., ceasing to display the first user interface and/or the second user interface). Ceasing to display visual content via the display component when prescribed conditions are met allows the computer system to automatically de-clutter the user interface and preserve screen real estate, thereby providing improved feedback (e.g., visual feedback) to the user and performing an operation when a set of conditions has been met without requiring further user input.

In some embodiments, the first user interface (e.g., 608) does not include the indication of the value of the first setting (e.g., as described above at FIG. 2B) corresponding to the first device (e.g., one or more light devices and/or playback devices as described above at FIGS. 2A-2E). In some embodiments, the first user interface does not include the indication of the value of the second setting corresponding to the second device (e.g., as described above at FIG. 2B).

In some embodiments, the first user interface (e.g., 608) does not include a background that is based on a default setting (e.g., as described above at FIG. 2B). In some embodiments, the second user interface (e.g., 618) does include a background (e.g., 618b) that is based on the default setting (e.g., as described above at FIG. 2C) (e.g. the first user interface that flashes up (e.g., the settings around the avatar) isn't based on a setting; while the second user interface (e.g., after the user interface with the settings for the avatar) can have the background that is based on the default setting (e.g., background can be filled or not) based on the volume of music). Having second user interface that includes a background that is based on a default setting and having the first user interface that is based on a default setting allows the computer system to limit information on the first user interface (e.g., a user interface with a heighten amount of animation and/or movement) while adding information on the second user interface (e.g., a user interface with reduced or no amount of animation and/or movement), thereby providing improved feedback (e.g., visual feedback) to the user and performing an operation when a set of conditions has been met without requiring further user input.

In some embodiments, the default setting corresponds to a media item. In some embodiments, the computer system (e.g., 600) is in communication with a first physical input mechanism (e.g., 616). In some embodiments, after detecting the presence of the first user (e.g., 610), the computer system detects an input (e.g., 605f and/or 605g) (e.g., a tap input and/or a non-tap input (e.g., a gaze input, an air gesture, a pointing gesture a swipe input, and/or a mouse click)) directed to the physical input mechanism. In some embodiments, in response to detecting the input directed to the first physical input mechanism, the computer system performs a media operation (e.g., playing media, pausing media, skipping to new media, reversing media, fast-forwarding media, and/or rewinding media) with respect to the media item (e.g., as described above at FIG. 2F). Performing a media operation with respect to the media item in response to detecting the input directed to the first physical input mechanism gives the user control over the computer system to cause a particular operation to be performed, thereby providing additional control options without cluttering the user interface with additional displayed controls.

In some embodiments, in accordance with a determination that the default setting has a first value (e.g., that corresponds to a first media item and/or a type of media item), the background (e.g., 618b) that is based on the default value has a first color characteristic (e.g., as described above at FIG. 2C) (e.g., hue, tint, color, shade, and/or highlighting). In some embodiments, in accordance with a determination that the default setting has a second value that is different from the first value, the background that is based on the default value has a second color characteristic that is different from the first visual characteristic (e.g., as described above at FIG. 2C). Having the background that has a different color characteristic when prescribed conditions are met allows the computer system to automatically display the background based on the value of the default setting that was set by the user, thereby providing additional control options without cluttering the user interface with additional displayed controls, providing improved feedback, and performing an operation when a set of conditions has been met without requiring further user input.

In some embodiments, the computer system (e.g., 600) is in communication with a second physical input mechanism (e.g., 616). In some embodiments, while the first user interface (e.g., 618) includes the background (618b) that is based on the default setting, the computer system detects rotation of the second physical input mechanism. In some embodiments, in response to detecting the rotation of the second physical input mechanism (and while detecting rotation of the second physical input mechanism), the computer system changes a visual characteristic (e.g., a color characteristic, hue, tint, amount of fill, highlighting, and/or shading) of the background to correspond to a current value of the default setting (e.g., as described above at FIGS. 2G and 2H), wherein the current value is selected based on the rotation (e.g., speed, acceleration, and/or direction) of the second physical input mechanism. Changing a visual characteristic of the background to correspond to a current value of the default setting in response to detecting the rotation of the second physical input mechanism allows the computer system to automatically display the background based on the value of the default setting that is set by the user, thereby providing additional control options without cluttering the user interface with additional displayed controls, providing improved feedback, and performing an operation when a set of conditions has been met without requiring further user input.

In some embodiments, while displaying the second user interface (e.g., 618), the computer system detects an input (e.g., 605i) (e.g., a tap input and/or a non-tap input (e.g., a gaze input, an air gesture, a pointing gesture a swipe input, and/or a mouse click)) directed to the second user interface. In some embodiments, in response to detecting input directed to the second user interface (e.g., 618), the computer system changes a background of the second user interface (e.g., as described above at FIG. 2J) (e.g., and changing a value corresponding to a setting). Changing a background of the second user interface in response to detecting input directed to the second user interface allows the computer system to automatically display the background based on the value of the default setting that is set by the user and/or based on user input directed to the computer system, thereby providing additional control options without cluttering the user interface with additional displayed controls, providing improved feedback, and performing an operation when a set of conditions has been met without requiring further user input.

In some embodiments, the computer system (e.g., 600) is in communication with a third physical input mechanism (e.g., 616). In some embodiments, the computer system detects a respective input (e.g., 605f, 605g, and/or 605i) (e.g., a tap input and/or a non-tap input (e.g., a gaze input, an air gesture, a pointing gesture a swipe input, and/or a mouse click)). In some embodiments, in response to detecting the respective input and in accordance with a determination that the respective input is directed to the second user interface (e.g., 618), the computer system configures the third physical input mechanism to cause the computer system (e.g., 600) to perform an operation (e.g., to change a different setting, to cause a value for a different setting to change, and/or to cause output of a device to change) in response to detecting input directed to the third physical input mechanism (e.g., as described above at FIG. 2J). In some embodiments, in response to detecting the respective input and in accordance with a determination that the respective input is directed to the first user interface (e.g., 608), the computer system forgoes configuring the third physical input mechanism to cause the computer system (e.g., 600) to perform an operation in response to detecting input directed to the third physical input mechanism (e.g., as described above at FIG. 2J). Choosing whether to configure the third physical input mechanism to cause the computer system to perform an operation in response to detecting input directed to the physical input mechanism when prescribed conditions are met allows the computer system to control when the third physical input mechanism is configured to cause the computer system to perform the operation, thereby performing an operation when a set of conditions has been met without requiring further user input.

Note that details of the processes described above with respect to process 800 (e.g., FIG. 4) are also applicable in an analogous manner to other methods described herein. For example, process 1000 optionally includes one or more of the characteristics of the various methods described above with reference to process 800. For example, an indication of how an output of a device is changing can be displayed using the techniques described below in relation to 800 on a device that is caused to provide the output using one or more techniques described above in relation to 1000. For brevity, these details are not repeated below.

FIGS. 5A-5C are provided to illustrate various examples with respect to how a respective user interface is displayed based on the location of the user. In some embodiments, a first respective computer system displays the user interface when the user is positioned at a first position. In some embodiments, a second respective computer system displays the user interface when the user is positioned at a second position. In some embodiments, the first respective computer system is closer to the first position than the second respective computer system and the second respective computer system is closer to the second position than the first respective computer system. In some embodiments, selectively displaying the user interface via a respective computer system allows a user to ascertain their positioning with respect to the first respective computer system and the second respective computer system.

FIGS. 5A-5C illustrate exemplary user interfaces displaying a user interface based on a location of a user in accordance with some examples. The user interfaces in these figures are used to illustrate the processes described below, including the processes in FIG. 6.

FIG. 5A illustrates computer system 900 and computer system 950. As illustrated in FIG. 5A, computer system 900 is a smartphone and includes display 904 (e.g., a display component) and computer system 950 is a smartphone and includes display 954 (e.g., a display component). However, it should be understood that the types of computer systems, user interfaces, user interface objects, and components described herein are merely exemplary and are provided to give context to the embodiments described herein. Both computer system 900 and computer system 950 are coupled to an external structure (e.g., a boat, an airplane, a car, and/or a trailer). At FIG. 5A, both computer system 900 and computer system 950 are in a sleep state. At FIG. 5A, because both computer system 900 and computer system 950 are in the sleep state, computer system 900 and computer system 950 not display a respective user interface and/or respective user interface objects on their respective displays. In some embodiments, computer system 900 and/or computer system 950 include a knob, a dial, a joystick, a touch-sensitive surface, a button, a slider, a television, a projector, a monitor, a smart display, a laptop, and/or a personal computer. In some embodiments, computer system 900 and/or computer system 950 include one or more components described above in relation to system 100.

FIG. 5A includes schematic 910. Schematic 910 is a visual aid that illustrates the positional relationship between computer system 900, computer system 950, and a user. As illustrated in FIG. 5A, schematic 910 includes representation of first computer system 912, representation of second computer system 914, and representation of user 916. Representation of first computer system 912 is representative of computer system 900, representation of second computer system 914 is representative of computer system 950, and representation of user 916 is representative of the user. Each of computer system 900, computer system 950, and the user are positioned within a common area (e.g., within the external structure). At FIG. 5A, as indicated by schematic 910 the user is positioned between computer system 900 and computer system 950 and computer system 900 is positioned to the left of computer system 950. At FIG. 5A, the user moves away from computer system 950 and towards computer system 900.

At FIG. 5B, as indicated by the positioning of representation of first computer system 912, representation of user 916, and representation of second computer system 914 within schematic 910, the user is positioned closer to computer system 900 than computer system 950. At FIG. 5B, a determination is made by a computer system (e.g., computer system 900, computer system 950, or a computer system that is external to computer system 900 and computer system 950) that the user is positioned closer to computer system 900 than computer system 950. Because a determination is made that the user is positioned closer to computer system 900 than computer system 950, computer system 900 displays an animation of welcome user interface 918 fading into display 904 over a period of time (e.g., 0.5-20 seconds) (e.g., and computer system 950 does not display welcome user interface 918) (e.g., using one or more techniques described above in relation to FIGS. 2A-2G). That is, whichever computer system the user is detected as being closer to displays welcome user interface 918. As illustrated in FIG. 5B, welcome user interface includes a welcome message to the user (e.g., “Welcome Kyle”) (e.g., using one or more techniques described above in relation to FIGS. 2A-2G). In some embodiments, computer system 900 ceases to display the animation of welcome user interface 918 fading into display 904 when a determination is made that the presence of the user is not detected for a predetermined amount of time (e.g., 1-120 seconds). In some embodiments, computer system 900 continues to display the animation of welcome user interface 918 fading into display 904 when a determination is made that the presence of the user is not detected for a predetermined amount of time. In some embodiments, computer system 900 displays welcome user interface 918 upon an initial determination (e.g., a first determination during a discrete time period) that the user is positioned closer to computer system 900 than computer system 950 and computer system 900 does not display welcome user interface 918 in response to subsequent determinations that the user is positioned closer to computer system 900 than computer system 950.

At FIG. 5B, when a determination is made that the user is positioned closer to computer system 900 than computer system 950, computer system 900 transitions from the sleep state to an active state. At FIG. 5B, computer system 950 remains in the sleep state. At FIG. 5B, the user moves away from computer system 900 and towards computer system 900. In some embodiments, computer system 900 displays welcome user interface 918 when a determination is made that that the user is within a predetermined distance (e.g., 0.25-10 feet) of computer system 900. In some embodiments, when a determination is made that the user is positioned at an equal distance from computer system 900 and computer system 950, both computer system 900 and computer system 950 display welcome user interface 918. In some embodiments, making the determination that the user is positioned closer to computer system 900 than computer system 950 includes detecting that the hand of the user is near display 904. In some embodiments, making the determination that the user is positioned closer to computer system 900 than computer system 950 includes detecting that the user is in a certain position (e.g., the user is sitting, standing, or laying down). In some embodiments, making the determination that the user is positioned closer to computer system 900 than computer system 950 includes detecting the presence of an external computer system (e.g., a computer system that is worn by the user (e.g., a smartwatch)) (e.g., a computer system that is external to computer system 900 and 950). In some embodiments, making the determination that the user is positioned closer to computer system 900 than computer system 950 includes detecting that a hand of the user is near a rotatable input mechanism of a respective computer system that is configured to control an operation of the respective computer system (e.g., the rotatable input mechanism is a part of the computer system that makes the determination that the user is positioned closer to computer system 900 than computer system 950). In some embodiments, computer system 900 and computer system 950 remain in the sleep state when a determination is made that the presence of the user is not detected. In some embodiments, when the presence of the user is not detected, computer systems 900 displays a representation of the physical environment (e.g., the physical environment within the external structure or outside of the external structure) on display 904 and displays display 904 with reflective properties (e.g., similar to the reflective properties of a mirror. In some embodiments, when the presence of the user is not detected, computer system 900 displays display 904 with a transparent appearance. In some embodiments, when the presence of the user is not detected, computer system 900 displays a representation of the physical environment within a representation of a window on display 904. In some embodiments, when the presence of the user is not detected, computer system 900 displays a user interface on display 904 that mimics a visual characteristic (e.g., tint, hue, and/or shade) of a portion of the external structure (e.g., the interior of the external structure and/or the external of the external structure). In some embodiments, when the presence of the user is not detected, computer system 950 mimics the display of computer system 900. In some embodiments, when the presence of the user is not detected, computer system 950 does not mimic the display of computer system 900.

At FIG. 5C, as indicated by the positioning of representation of first computer system 912, representation of user 916, and representation of second computer system 914, within schematic 910, the user is positioned closer to computer system 950 than computer system 900. Further, at FIG. 5C, a determination is made (e.g., by computer system 900, computer system 950 and/or a computer system that is external to computer system 900 and computer system 950) that the user is positioned closer to computer system 950 than computer system 900. Because a determination is made that the user is positioned closer to computer system 950 than computer system 900, computer system 950 displays welcome user interface 918 and computer system 900 ceases to display welcome user interface 918 (e.g., using one or more techniques described above in relation to FIGS. 2A-2G). Further, at FIG. 5C, because a determination is made that the user is positioned closer to computer system 950 than computer system 900, computer system 900 transitions from the active state to the sleep state and computer system 950 transitions from the sleep state to the active state. In some embodiments, neither computer system 900 nor computer system 850 display welcome user interface 918 when a determination is made that the user is not within a predetermined distance (e.g., 0.5-10 feet) of either computer system 900 or computer system 950. In some embodiments, while computer system 900 displays welcome user interface 918, computer system 950 displays a respective welcome user interface when a determination is made that that a respective user is positioned closer to computer system 950 than computer system 900. In some embodiments, computer system 900 displays welcome user interface 918 with a first welcome message for a first user and a second welcome message for a second user when a determination is made that the first user and the second user are positioned closer to computer system 900 than computer system 950.

FIG. 6 is a flow diagram illustrating a method (e.g., process 1000) for displaying a user interface based on a location of a user in accordance with some examples. Some operations in process 1000 are, optionally, combined, the orders of some operations are, optionally, changed, and some operations are, optionally, omitted.

As described below, process 1000 provides an intuitive way for displaying a user interface based on a location of a user. Process 1000 reduces the cognitive burden on a user for displaying a user interface based on a location of a user, thereby creating a more efficient human-machine interface. For battery-operated computing devices, enabling a user to display a user interface based on a location of user faster and more efficiently conserves power and increases the time between battery charges.

In some embodiments, process 1000 is performed at a computer system (e.g., 900 and/or 950) that is in communication with a first display component (e.g., 904 and/or 954) (e.g., a display screen and/or a touch-sensitive display) and a second display component (e.g., 904 and/or 954), different from the first display component. In some embodiments, the computer system is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the computer system is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras). In some embodiments, the computer system is in communication with a first device (e.g., an external device, an internal device, a fan, a thermostat, a window, a set of blinds, a speaker, a microphone, and/or a door). In some embodiments, the first display component is mounted to (and/or positioned in and/or coupled to) a first respective location in the physical environment and the second display component is mounted to a second respective location in the physical environment.

The computer system detects (1002) a presence of a user (e.g., 916) (e.g., detecting a body part of the user near a predetermined location, the computer system, and/or a portion of the computer system; detecting movement of the user, and/or detecting a device and/or computer system that is associated with the user) in a physical environment.

In response to (1004) detecting the presence of the user (e.g., 916) and in accordance with a determination that the user (e.g., 916) is at a first location in the physical environment (e.g., as described at FIG. 5B) (e.g., a location that is closer to a first area of the physical environment than a second area of the physical environment), the computer system displays (1006), via the first display component (e.g., 904 and/or 954), a welcome user interface (e.g., 918) that includes an indication of how output of one or more devices is being configured based on detecting the presence of the user without displaying, via the second display component (e.g., 904 and/or 954), a second welcome user interface (e.g., the welcome user interface, a different welcome user interface, and/or any welcome user interface).

In response to (1004) detecting the presence of the user (e.g., 916) and in accordance with a determination that the user (e.g., 916) is at a second location, different from the first location, in the physical environment (e.g., as described above at FIG. 5C) (e.g., a location that is closer to a first area of the physical environment than a second area of the physical environment), the computer system displays (1008), via the second display component (e.g., 904 and/or 954), the welcome user interface (e.g., 918) without displaying, via the first display component (e.g., 904 and/or 954), a third welcome user interface (the welcome user interface, a different welcome user interface, and/or any welcome user interface). Displaying the welcome user interface on a particular device and not display the welcome user interface on another device when prescribed conditions are met allows the computer system to intelligently select where to display the user interface (e.g., one that is closer to the location of the user), thereby performing an operation when a set of conditions has been met without requiring further user input and/or providing additional control options without cluttering the user interface with additional displayed controls.

In some embodiments, the presence of the user (e.g., 916) is detected at a third location. In some embodiments, after detecting the presence of the user at the first location (e.g., 916 at FIG. 5B) and (In some embodiments, while) displaying, via the first display component (e.g., 904 and/or 954), the welcome user interface (e.g., 918), the computer system detects the presence of the user at a fourth location that is different from the third location (e.g., 916 at FIG. 5C). In some embodiments, in response to detecting the presence of the user at the fourth location and in accordance with a determination that the fourth location is the second location, the computer system displays, via the second display component (e.g., 904 and/or 954), the welcome user interface (e.g., as described above at FIG. 5C). In some embodiments, the welcome user interface is displayed concurrently with first display component and the second display component. In some embodiments, in accordance with a determination that the fourth location is the first location, the computer system does not display, via the second display component, the welcome user interface. Displaying, via the second display component, the welcome user interface in response to presence of the user at the fourth location and after detecting the presence of the user at the first location and displaying, via the first display component, the welcome user interface when prescribed conditions are met allows the computer system to intelligently switch and choose where to display the user interface as the user moves between locations, thereby performing an operation when a set of conditions has been met without requiring further user input and/or providing additional control options without cluttering the user interface with additional displayed controls.

In some embodiments, in response to detecting the presence of the user (e.g., 916) at the fourth location and in accordance with a determination that the fourth location is the second location, the computer system ceases to display, via the first display component (e.g., 904 and/or 954), the welcome user interface (e.g., 918) after a first predetermined period of time (e.g., as described above at FIG. 5C). Ceasing to display, via the first display component, the welcome user interface after a first predetermined period of time in response to presence of the user at the fourth location and after detecting the presence of the user at the first location and displaying, via the first display component, the welcome user interface when prescribed conditions are met allows the computer system to intelligently stop display of the welcome user interface via display components that are no longer needed, thereby performing an operation when a set of conditions has been met without requiring further user input and/or providing additional control options without cluttering the user interface with additional displayed controls.

In some embodiments, while displaying the welcome user interface (e.g., 918), the computer system detects that the presence of the user (e.g., 916) has not been detected for a second predetermined period of time. In some embodiments, in response to detecting that the presence of the user has not been detected for the second predetermined period of time, the computer system ceases to display the welcome user interface (e.g., as described above at FIG. 5B). Ceasing to display the welcome user interface in response to detecting that the presence of the user has not been detected for the second predetermined period of time allows the computer system to intelligently stop display of the welcome user interface via display components that are no longer needed, thereby performing an operation when a set of conditions has been met without requiring further user input and/or providing additional control options without cluttering the user interface with additional displayed controls.

In some embodiments, while displaying the welcome user interface (e.g., 918), the computer system detects that the presence of the user (e.g., 916) has not been detected for a third predetermined period of time. In some embodiments, in response to detecting that the presence of the user has not been detected for the third predetermined period of time, the computer system continues to display the welcome user interface (e.g., as described above at FIG. 5B). In some embodiments, the first predetermined period of time is the same as the second predetermined period of time. Continuing to display the welcome user interface in response to detecting that the presence of the user has not been detected for the second predetermined period of time allows the computer system to intelligently continue display of the welcome user interface via display components, thereby performing an operation when a set of conditions has been met without requiring further user input and/or providing additional control options without cluttering the user interface with additional displayed controls.

In some embodiments, while displaying the welcome user interface (e.g., 918), the computer system detects that a display (e.g., 904 and/or 954) has received no interaction within a predetermined period of time. In some embodiments, in response to detecting that the display has received no interaction within a predetermined period of time, the computer system ceases to display the welcome user interface (e.g., as described above at FIG. 5B). In some embodiments, in response to detecting that the display has received interaction within a predetermined period of time, the computer system continues to display the welcome user interface. Ceasing to display the welcome user interface in response to detecting that the display has received no interaction within a predetermined period of time intelligently stop display of the welcome user interface via display components that are no longer needed, thereby performing an operation when a set of conditions has been met without requiring further user input and/or providing additional control options without cluttering the user interface with additional displayed controls.

In some embodiments, detecting the presence of the user (e.g., 916) includes detecting that a user is in a respective position (e.g., as described above at FIG. 5B) (e.g., a particular position and/or a specific position) (e.g., sitting down, standing up, sitting down at a particular location, sitting down in a particular seat, and/or kneeling at a particular location). Displaying the welcome user interface on a particular device and not display the welcome user interface on another device in response to detecting that a user is in a respective position when prescribed conditions are met allows the computer system to intelligently select where to display the user interface (e.g., one that is closer to the location of the user), thereby performing an operation when a set of conditions has been met without requiring further user input and/or providing additional control options without cluttering the user interface with additional displayed controls.

In some embodiments, detecting presence of the user (e.g., 916) includes detecting a device (e.g., as described above at FIG. 5B) (e.g., a wearable device, a fitness tracking device, and/or a smartwatch). Displaying the welcome user interface on a particular device and not display the welcome user interface on another device in response to detecting that a device when prescribed conditions are met allows the computer system to intelligently select where to display the user interface (e.g., one that is closer to the location of the device), thereby performing an operation when a set of conditions has been met without requiring further user input and/or providing additional control options without cluttering the user interface with additional displayed controls.

In some embodiments, detecting presence of the user (e.g., 916) includes detecting that a body part (e.g., a hand, finger, a wrist, an arm, and/or a foot) of the user is within a first predetermined distance (e.g., 0.1-4 meters) from a display (e.g., 904 and/or 954) (e.g., the display component and/or another display and/or display component). In some embodiments, detecting presence of the user includes detecting an intent to control the display (e.g., a gaze, a body part, and/or a gesture that is directed to and/or within the predetermined distance and/or is near the display). Displaying the welcome user interface on a particular device and not display the welcome user interface on another device in response to detecting that a body part of the user is within a first predetermined distance from a display when prescribed conditions are met allows the computer system to intelligently select where to display the user interface (e.g., one that is closer to the location of the device), thereby performing an operation when a set of conditions has been met without requiring further user input and/or providing additional control options without cluttering the user interface with additional displayed controls.

In some embodiments, the computer system (e.g., 900 and/or 950) is in communication with a physical input mechanism. In some embodiments, the physical input mechanism is configured to cause the computer system to perform an operation in response to input directed to the physical input mechanism. In some embodiments, detecting presence of the user (e.g., 916) includes detecting that a body part (e.g., a hand, finger, a wrist, an arm, and/or a foot) of the user is within a second predetermined distance (e.g., 0.1-4 meters) from the physical input mechanism (e.g., as described above at FIG. 5B) (e.g., the display component and/or another display and/or display component). In some embodiments, detecting presence of the user includes detecting an intent to control the display (e.g., a gaze, a body part, and/or a gesture that is directed to and/or within the predetermined distance and/or is near the display). Displaying the welcome user interface on a particular device and not display the welcome user interface on another device in response to detecting that body part of the user is within a second predetermined distance from the physical input mechanism when prescribed conditions are met allows the computer system to intelligently select where to display the user interface (e.g., one that is closer to the location of the device), thereby performing an operation when a set of conditions has been met without requiring further user input and/or providing additional control options without cluttering the user interface with additional displayed controls.

In some embodiments, before detecting the presence of the user (e.g., 916), the first display component (e.g., 904 and/or 954) is in a first inactive state and the second display component (e.g., 904 and/or 954) is in a second inactive state (e.g., as described above at FIG. 5A). In some embodiments, in response to detecting the presence of the user and in accordance with a determination that the user is at the first location in the physical environment, the computer system transitions the first display component from the first inactive state to a first active state (e.g., as described above at FIGS. 5B and/or 5C). In some embodiments, in response to detecting the presence of the user and in accordance with a determination that the user is at a second location, different from the first location, the computer system transitions the first display component from the second inactive state to a second active state (e.g., as described above at FIGS. 5B and/or 5C) (e.g., without transitioning the first display component from the first inactive state to the first active state). Transitioning a particular display component from an inactive state to an active state when prescribed conditions are met allows the computer system to intelligently control the state of the particular display component based on when the display component is needed to display content, thereby performing an operation when a set of conditions has been met without requiring further user input and/or providing additional control options without cluttering the user interface with additional displayed controls.

In some embodiments, in response to no longer detecting the presence of the user (e.g., 916), the computer system displays (e.g., via the first display generation, the second generation component, the display component that was displaying the welcome user interface before the presence of the user was no longer detected, and/or the display component that was displaying the welcome user interface in response to the presence of the user being detected) a user interface that has a color that is based on images being captured by a camera (e.g., that mimics a window and/or to display images outside of the computer system) (e.g., as described above at FIG. 5B). Displaying a user interface has a color that is based on images being capture by a camera in response to no longer detecting the presence of the user allows the computer system to use the display component to display other content when the presence of the user is no longer detected, thereby performing an operation when a set of conditions has been met without requiring further user input and/or providing additional control options without cluttering the user interface with additional displayed controls.

In some embodiments, the display (e.g., 904 and/or 954) that included (e.g., displaying and/or visually showed) the welcome user interface (e.g., 918) in response to detecting the presence of the user (e.g., 916) includes a visual appearance with a color that is associated with a physical environment (e.g., a material of the computer system, a material on a wall, a material on a door, and/or the material on a ceiling) (e.g., as described at FIG. 5B).

Note that details of the processes described above with respect to process 1000 (e.g., FIG. 6) are also applicable in an analogous manner to the methods described herein. For example, process 800 optionally includes one or more of the characteristics of the various methods described above with reference to process 1000. For example, an indication of how an output of a device is changing can be displayed using the techniques described below in relation to 800 on a device that is caused to provide the output using one or more techniques described above in relation to 1000. For brevity, these details are not repeated below.

This disclosure, for purpose of explanation, has been described with reference to specific embodiments. The discussions above are not intended to be exhaustive or to limit the disclosure and/or the claims to the specific embodiments. Modifications and/or variations are possible in view of the disclosure. Some embodiments were chosen and described in order to explain principles of techniques and their practical applications. Others skilled in the art are thereby enabled to utilize the techniques and various embodiments with modifications and/or variations as are suited to a particular use contemplated.

Although the disclosure and embodiments have been fully described with reference to the accompanying drawings, it is to be noted that various changes and/or modifications will become apparent to those skilled in the art. Such changes and/or modifications are to be understood as being included within the scope of this disclosure and embodiments as defined by the claims.

It is the intent of this disclosure that any personal information of users should be gathered, managed, and handled in a way to minimize risks of unintentional and/or unauthorized access and/or use.

Therefore, although this disclosure broadly covers use of personal information to implement one or more embodiments, this disclosure also contemplates that embodiments can be implemented without the need for accessing such personal information.

1. A method, comprising:
at a computer system that is in communication with a display component and a first device:
while the first device is providing first output, detecting a presence of a user; and
in response to detecting the presence of the user:
in accordance with a determination that a value of a setting corresponding to the user is a first value and a value of a characteristic of an environment is a second value, causing the first device to provide second output that is different from the first output;
in accordance with a determination that the value of the setting corresponding to the user is a third value, different from the first value, and the value of the characteristic of the environment is the second value, causing the first device to provide third output that is different from the second output and the first output;
in accordance with a determination that the value of the setting corresponding to the user is the first value and the value of the characteristic of the environment is a fourth value, different from the second value, causing the first device to provide fourth output that is different from the third output, the second output, and the first output; and
in accordance with a determination that the value of the setting corresponding to the user is the third value and the value of the characteristic of the environment is the fourth value, causing the first device to provide fifth output that is different from the fourth output, the third output, the second output, and the first output.

2. The method of claim 1, further comprising:
in response to detecting the presence of the user:
in accordance with a determination that the value of the setting corresponding to the user is the first value and the value of the characteristic of the environment is the second value, displaying, via the display component, an indication that the first device is being transitioned from providing the first output to providing the second output;
in accordance with a determination that the value of the setting corresponding to the user is a third value and the value of the characteristic of the environment is the second value, displaying, via the display component, an indication that the first device is being transitioned from providing the first output to providing the third output;
in accordance with a determination that the value of the setting corresponding to the user is the first value and the value of the characteristic of the environment is the fourth value, displaying, via the display component, an indication that the first device is being transitioned from providing the first output to providing the fourth output; and
in accordance with a determination that the value of the setting corresponding to the user is the third value and the value of the characteristic of the environment is the fourth value, displaying, via the display component, an indication that the first device is being transitioned from providing the first output to providing the fifth output.

3. The method of claim 2, wherein the computer system is in communication with a second display component, the method further comprising:
in response to detecting a presence of the user is detected within a first predetermined distance from the display component:
in accordance with a determination that the value of the setting corresponding to the user is the first value and the value of the characteristic of the environment is the second value, forgoing displaying, via the second display component, the indication that the first device is being transitioned from providing the first output to providing the second output;
in accordance with a determination that the value of the setting corresponding to the user is a third value and the value of the characteristic of the environment is the second value, forgoing displaying, via the second display component, the indication that the first device is being transitioned from providing the first output to providing the third output;
in accordance with a determination that the value of the setting corresponding to the user is the first value and the value of the characteristic of the environment is the fourth value, forgoing displaying, via the second display component, the indication that the first device is being transitioned from providing the first output to providing the fourth output; and
in accordance with a determination that the value of the setting corresponding to the user is the third value and the value of the characteristic of the environment is the fourth value, forgoing displaying, via the second display component, the indication that the first device is being transitioned from providing the first output to providing the fifth output; and
in response to detecting the presence of the user is detected within the first predetermined distance from the second display component:
in accordance with a determination that the value of the setting corresponding to the user is the first value and the value of the characteristic of the environment is the second value, displaying, via the second display component, the indication that the first device is being transitioned from providing the first output to providing the second output;
in accordance with a determination that the value of the setting corresponding to the user is a third value and the value of the characteristic of the environment is the second value, displaying, via the second display component, the indication that the first device is being transitioned from providing the first output to providing the third output;
in accordance with a determination that the value of the setting corresponding to the user is the first value and the value of the characteristic of the environment is the fourth value, displaying, via the second display component, the indication that the first device is being transitioned from providing the first output to providing the fourth output; and
in accordance with a determination that the value of the setting corresponding to the user is the third value and the value of the characteristic of the environment is the fourth value, displaying, via the second display component, the indication that the first device is being transitioned from providing the first output to providing the fifth output.

4. The method of claim 2, wherein the setting is a first setting, the method further comprising:
in response to detecting the presence of the user:
in accordance with a determination that a value of a second setting, different from the first setting, is a sixth value and the value of a second characteristic of the environment is the second value, causing a second device to provide sixth output; and
in accordance with a determination that the value of the second setting is the sixth value and the value of the second characteristic of the environment is the second value, wherein the seventh value that is different from the sixth value, causing the second device to provide seventh output that is different from the sixth output.

5. The method of any one of claim 2, further comprising:
in accordance with a determination that the value of the second setting is the sixth value and the value of the second characteristic of the environment is the second value, displaying, via the display component, the indication that the second device is being transitioned from providing a respective output to providing the sixth output; and
in accordance with a determination that the value of the second setting is the sixth value and the value of the second characteristic of the environment is the second value, displaying, via the display component, the indication that the second device is being transitioned from providing the respective output to providing the seventh output.

6. The method of claim 3, further comprising:
in response to detecting the presence of the user:
in accordance with a determination that the value of the setting corresponding to the user is the first value and the value of the characteristic of the environment is the second value, displaying, via the display component, an indication of an identity of the user concurrently with the indication that the first device is being transitioned from providing the first output to providing the second output;
in accordance with a determination that the value of the setting corresponding to the user is a third value and the value of the characteristic of the environment is the second value, displaying, via the display component, the indication of the identity of the user concurrently with the indication that the first device is being transitioned from providing the first output to providing the third output;
in accordance with a determination that the value of the setting corresponding to the user is the first value and the value of the characteristic of the environment is the fourth value, displaying, via the display component, the indication of the identity of the user concurrently with the indication that the first device is being transitioned from providing the first output to providing the fourth output; and
in accordance with a determination that the value of the setting corresponding to the user is the third value and the value of the characteristic of the environment is the fourth value, displaying, via the display component, the indication of the identity of the user concurrently with the indication that the first device is being transitioned from providing the first output to providing the fifth output.

7. The method of claim 3, wherein displaying the indication that the first device is being transitioned from providing the first output to providing the second output, includes displaying an animation, wherein:
in accordance with a determination that a first set of criteria is met, the animation includes a first property; and
in accordance with a determination that a second set of criteria is met, the animation includes a second property different from the first property.

8. The method of claim 1, further comprising:
while the first device is providing the first output, detecting a presence of a second user different from the user; and
in response to detecting the presence of the second user:
in accordance with a determination that the value of the setting corresponding to the second user is a first respective value, different from the first value, and the value of the characteristic of the environment is the second value, causing the first device to provide output that is different from the second output;
in accordance with a determination that the value of the setting corresponding to the second user is a second respective value, different from the third value, and the value of the characteristic of the environment is the second value, causing the first device to provide output that is different from the third output;
in accordance with a determination that the value of the setting corresponding to the second user is the first respective value and the value of the characteristic of the environment is the fourth value, causing the first device to provide output that is different from the fourth output; and
in accordance with a determination that the value of the setting corresponding to the user is the third value and the value of the characteristic of the environment is the fourth value, causing the first device to provide output that is different from the fifth output.

9. The method of claim 1, wherein detecting the presence of the user includes detecting that a user is in a respective position.

10. The method of claim 1, wherein detecting presence of the user includes detecting a device.

11. The method of claim 1, wherein detecting presence of the user includes detecting that a body part of the user is within a predetermined distance from a display.

12. The method of claim 1, wherein the first device is a local device.

13. The method of claim 1, wherein the first device is a global device.

14.-17. (canceled)

18. A non-transitory computer-readable storage medium storing one or more programs configured to be executed by one or more processors of a computer system that is in communication with a display component and a first device, the one or more programs including instructions for:
while the first device is providing first output, detecting a presence of a user; and
in response to detecting the presence of the user:
in accordance with a determination that a value of a setting corresponding to the user is a first value and a value of a characteristic of an environment is a second value, causing the first device to provide second output that is different from the first output;
in accordance with a determination that the value of the setting corresponding to the user is a third value, different from the first value, and the value of the characteristic of the environment is the second value, causing the first device to provide third output that is different from the second output and the first output;
in accordance with a determination that the value of the setting corresponding to the user is the first value and the value of the characteristic of the environment is a fourth value, different from the second value, causing the first device to provide fourth output that is different from the third output, the second output, and the first output; and
in accordance with a determination that the value of the setting corresponding to the user is the third value and the value of the characteristic of the environment is the fourth value, causing the first device to provide fifth output that is different from the fourth output, the third output, the second output, and the first output.

19. A computer system that is in communication with a display component and a first device, comprising:
one or more processors; and
memory storing one or more programs configured to be executed by the one or more processors, the one or more programs including instructions for:
while the first device is providing first output, detecting a presence of a user; and
in response to detecting the presence of the user:
in accordance with a determination that a value of a setting corresponding to the user is a first value and a value of a characteristic of an environment is a second value, causing the first device to provide second output that is different from the first output;
in accordance with a determination that the value of the setting corresponding to the user is a third value, different from the first value, and the value of the characteristic of the environment is the second value, causing the first device to provide third output that is different from the second output and the first output;
in accordance with a determination that the value of the setting corresponding to the user is the first value and the value of the characteristic of the environment is a fourth value, different from the second value, causing the first device to provide fourth output that is different from the third output, the second output, and the first output; and
in accordance with a determination that the value of the setting corresponding to the user is the third value and the value of the characteristic of the environment is the fourth value, causing the first device to provide fifth output that is different from the fourth output, the third output, the second output, and the first output.

20.-65. (canceled)
